(19) United States
(12) Patent Application Publication
(10) Pub. No.: US 2026/0121700 A1
(43) Pub. Date: Apr. 30, 2026

(54) CODEBOOK DESIGNS FOR CHANNEL STATE INFORMATION REPORTING WITH SPARSE ANTENNA ARRAYS

(71) Applicant: QUALCOMM INCORPORATED, San Diego, CA (US)

(72) Inventors: Wei Xi, Beijing (CN); Min Huang, Beijing (CN); Chao Wei, Beijing (CN); Hao Xu, Beijing (CN); Liangming Wu, Beijing (CN); Chenxi Hao, Beijing (CN); Jing Dai, Beijing (CN); Rui Hu, Beijing (CN)

(21) Appl. No.: 18/867,395

(22) PCT Filed: Jul. 11, 2022
(86) PCT No.: PCT/CN2022/104907

§ 371 Date: Nov. 19, 2024

(51) Int. Cl. H04B 7/0456

(52) U.S. Cl. CPC H04B 7/0456

(57) ABSTRACT

Methods, systems, and devices for wireless communications are described. Techniques described my support dedicated codebooks for sparse antenna arrays, and channel state information (CSI) reporting procedures with reduced overhead. Precoding matrix indicator (PMI) reporting (e.g., in a CSI report) may be based on such dedicated codebook structures. For a CSI report for sparse antenna arrays, each precoding vector for each transmission layer may be constructed from two sub-vectors. Each sub-vector may include an overlapping entry (e.g., one entry in the first sub-vector is the same as one entry in the other sub-vector). Each sub-vector may correspond to an antenna subarray. The overlapping entry may correspond to a same antenna element in both of the two subarrays. The network may provide a UE with an indication of a sparse codebook type, and one or more parameter values for the sparse codebook type.

### CROSS REFERENCE

The present Application is a 371 national stage filing of International PCT Application No. PCT/CN2022/104907 by Xi et al. entitled “CODEBOOK DESIGNS FOR CHANNEL STATE INFORMATION REPORTING WITH SPARSE ANTENNA ARRAYS,” filed Jul. 11, 2022, which is assigned to the assignee hereof, and which is expressly incorporated by reference in its entirety herein.

### FIELD OF TECHNOLOGY

The following relates to wireless communications, including codebook designs for channel state information (CSI) reporting with sparse antenna arrays.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support codebook designs for channel state information (CSI) reporting with sparse antenna arrays. For example, techniques described herein may support dedicated codebooks for sparse antenna arrays, and CSI reporting procedures with reduced overhead. Precoding matrix indicator (PMI) reporting (e.g., in a CSI report) may be based on such dedicated codebook structures. For a CSI report for sparse antenna arrays, each precoding vector for each transmission layer may be constructed from two sub-vectors. Each sub-vector may include an overlapping entry (e.g., one entry in the first sub-vector is the same as one entry in the other sub-vector). Each sub-vector may correspond to an antenna array (e.g., two concatenated uniform subarrays of a nested sparse antenna array, or two interleaved uniform subarrays of a coprime sparse antenna array, among other examples). The overlapping entry may correspond to a same antenna element in both of the two subarrays (the two concatenated or interleaved subarrays). The network may provide a user equipment (UE) with an indication of a sparse codebook type (e.g., co-prime or nested, etc.), and one or more parameter values for the sparse codebook type (e.g., N representing the total number of antenna elements for a nested sparse antenna array, or P and Q values for interleaving two uniform subarrays for a co-prime sparse antenna array).

The network entity may transmit channel state information reference signals (CSI-RSs) using the sparse antenna array. The UE may receive the CSI-RSs and perform measurements thereon. The UE may report, in the PMI of the CSI report (e.g., using the parameters indicated in the configuration information), a precoding vector for each transmission layer, each precoding vector constructed of two sub-vectors. For each sub-vector, one entry may be the same, and may correspond to a single antenna element of a sparse antenna array. The network entity may utilize the PMI to precode subsequent downlink signaling, and may perform transmissions using the sparse antenna array, achieving the various benefits of spare antenna transmissions.

A method for wireless communications at a user equipment (UE) is described. The method may include receiving a control message including an indication of a codebook type associated with a sparse antenna array at a network entity, and one or more parameter values associated with the codebook type, receiving one or more CSI-RSs according to the codebook type, and transmitting a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry.

An apparatus for wireless communications at a UE is described. The apparatus may include a processor, memory coupled with the processor, and instructions stored in the memory. The instructions may be executable by the processor to cause the apparatus to receive a control message including an indication of a codebook type associated with a sparse antenna array at a network entity, and one or more parameter values associated with the codebook type, receive one or more CSI-RS according to the codebook type, and transmit a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry.

Another apparatus for wireless communications at a UE is described. The apparatus may include means for receiving a control message including an indication of a codebook type associated with a sparse antenna array at a network entity, and one or more parameter values associated with the codebook type, means for receiving one or more CSI-RSs according to the codebook type, and means for transmitting a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry.

A non-transitory computer-readable medium storing code for wireless communications at a UE is described. The code may include instructions executable by a processor to receive a control message including an indication of a codebook type associated with a sparse antenna array at a network entity, and one or more parameter values associated with the codebook type, receive one or more CSI-RSs according to the codebook type, and transmit a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry.

In some examples of the method, apparatuses, and non-transitory computer-readable medium described herein, transmitting the CSI report may include operations, features, means, or instructions for generating the first sub-vector according to a first uniform arrangement corresponding to the first subset of antennas and the second sub-vector according to a second uniform arrangement corresponding to the second subset of antennas, and where the sparse antenna array includes a concatenation of the first uniform arrangement and the second uniform arrangement.

In some examples of the method, apparatuses, and non-transitory computer-readable medium described herein, the one or more parameter values include a parameter value indicating a total number of antenna elements in the sparse array and the concatenation may be based on the parameter value indicating the total number of antenna elements.

In some examples of the method, apparatuses, and non-transitory computer-readable medium described herein, transmitting the CSI report may include operations, features, means, or instructions for generating the first sub-vector according to a first uniform arrangement corresponding to the first subset of antennas and the second sub-vector according to a second uniform arrangement corresponding to the second subset of antennas, and where the sparse antenna array includes an interleaving of the first uniform arrangement and the second uniform arrangement.

In some examples of the method, apparatuses, and non-transitory computer-readable medium described herein, the one or more parameter values include a first co-prime integer value and a second co-prime integer value and the interleaving may be based on the first co-prime integer value and the second co-prime integer value.

Some examples of the method, apparatuses, and non-transitory computer-readable medium described herein may further include operations, features, means, or instructions for transmitting a capability message indicating that the UE may be capable of receiving downlink signaling via the codebook type associated with the sparse antenna array, where receiving the control message may be based on transmitting the capability message.

In some examples of the method, apparatuses, and non-transitory computer-readable medium described herein, the at least one common entry shared between the first sub-vector and the second sub-vector correspond to a same antenna element of the sparse antenna array.

Some examples of the method, apparatuses, and non-transitory computer-readable medium described herein may further include operations, features, means, or instructions for receiving, based on transmitting the CSI report, a downlink transmission and decoding the downlink transmission based on the first precoding vector.

In some examples of the method, apparatuses, and non-transitory computer-readable medium described herein, the first precoding vector may be one of a set of multiple precoding vectors, each of the set of multiple precoding vectors corresponding to a respective transmission layer of a set of multiple transmission layers.

In some examples of the method, apparatuses, and non-transitory computer-readable medium described herein, the sparse antenna array includes a set of multiple antenna elements that may be unevenly spaced with reference to each other on an antenna panel of the network entity.

In some examples of the method, apparatuses, and non-transitory computer-readable medium described herein, receiving the control message may include operations, features, means, or instructions for receiving a downlink control information message, a radio resource control message, a media access control (MAC) control element (CE), or any combination thereof.

A method for wireless communications at a network entity is described. The method may include outputting a control message including an indication of a codebook type associated with a sparse antenna array at the network entity, and one or more parameter values associated with the codebook type, outputting one or more CSI-RSs according to the codebook type, and obtaining a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry.

An apparatus for wireless communications at a network entity is described. The apparatus may include a processor, memory coupled with the processor, and instructions stored in the memory. The instructions may be executable by the processor to cause the apparatus to output a control message including an indication of a codebook type associated with a sparse antenna array at the network entity, and one or more parameter values associated with the codebook type, output one or more CSI-RSs according to the codebook type, and obtain a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry.

Another apparatus for wireless communications at a network entity is described. The apparatus may include means for outputting a control message including an indication of a codebook type associated with a sparse antenna array at the network entity, and one or more parameter values associated with the codebook type, means for outputting one or more CSI-RSs according to the codebook type, and means for obtaining a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry.

A non-transitory computer-readable medium storing code for wireless communications at a network entity is described. The code may include instructions executable by a processor to output a control message including an indication of a codebook type associated with a sparse antenna array at the network entity, and one or more parameter values associated with the codebook type, output one or more CSI-RSs according to the codebook type, and obtain a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry.

In some examples of the method, apparatuses, and non-transitory computer-readable medium described herein, and the method, apparatuses, and non-transitory computer-readable medium may include further operations, features, means, or instructions for precoding a downlink transmission based on the first sub-vector according to a first uniform arrangement corresponding to the first subset of antennas and the second sub-vector according to a second uniform arrangement corresponding to the second subset of antennas, where the sparse antenna array includes a concatenation of the first uniform arrangement and the second uniform arrangement and outputting the downlink transmission based on the precoding.

In some examples of the method, apparatuses, and non-transitory computer-readable medium described herein, the one or more parameter values include a parameter value indicating a total number of antenna elements in the sparse array and the concatenation may be based on the parameter value indicating the total number of antenna elements.

In some examples of the method, apparatuses, and non-transitory computer-readable medium described herein, and the method, apparatuses, and non-transitory computer-readable medium may include further operations, features, means, or instructions for precoding a downlink transmission based on the first sub-vector according to a first uniform arrangement corresponding to the first subset of antennas and the second sub-vector according to a second uniform arrangement corresponding to the second subset of antennas, where the sparse antenna array includes an interleaving of the first uniform arrangement and the second uniform arrangement and outputting the downlink transmission based on the precoding.

In some examples of the method, apparatuses, and non-transitory computer-readable medium described herein, the one or more parameter values include a first co-prime integer value and a second co-prime integer value and the interleaving may be based on the first co-prime integer value and the second co-prime integer value.

Some examples of the method, apparatuses, and non-transitory computer-readable medium described herein may further include operations, features, means, or instructions for obtaining a capability message indicating that a UE may be capable of receiving downlink signaling via the codebook type associated with the sparse antenna array, where outputting the control message may be based on obtaining the capability message.

In some examples of the method, apparatuses, and non-transitory computer-readable medium described herein, the at least one common entry shared between the first sub-vector and the second sub-vector correspond to a same antenna element of the sparse antenna array.

In some examples of the method, apparatuses, and non-transitory computer-readable medium described herein, the first precoding vector may be one of a set of multiple precoding vectors, each of the set of multiple precoding vectors corresponding to a respective transmission layer of a set of multiple transmission layers.

In some examples of the method, apparatuses, and non-transitory computer-readable medium described herein, the sparse antenna array includes a set of multiple antenna elements that may be unevenly spaced with reference to each other on an antenna panel of the network entity.

In some examples of the method, apparatuses, and non-transitory computer-readable medium described herein, outputting the control message may include operations, features, means, or instructions for outputting a downlink control information message, a radio resource control message, a MAC-CE, or any combination thereof.

(This summary will be completed upon final approval of the claims)

### BRIEF DESCRIPTION OF THE DRAWINGS

FIG. 1 illustrates an example of a wireless communications system that supports codebook designs for channel state information (CSI) reporting with sparse antenna arrays in accordance with one or more aspects of the present disclosure.

FIG. 2 illustrates an example of a wireless communications system that supports codebook designs for CSI reporting with sparse antenna arrays in accordance with one or more aspects of the present disclosure.

FIG. 3 illustrates an example of a sparse antenna array scheme that supports codebook designs for CSI reporting with sparse antenna arrays in accordance with one or more aspects of the present disclosure.

FIG. 4 illustrates an example of a sparse antenna array scheme that supports codebook designs for CSI reporting with sparse antenna arrays in accordance with one or more aspects of the present disclosure.

FIG. 5 illustrates an example of a process flow that supports codebook designs for CSI reporting with sparse antenna arrays in accordance with one or more aspects of the present disclosure.

FIGS. 6 and 7 show block diagrams of devices that support codebook designs for CSI reporting with sparse antenna arrays in accordance with one or more aspects of the present disclosure.

FIG. 8 shows a block diagram of a communications manager that supports codebook designs for CSI reporting with sparse antenna arrays in accordance with one or more aspects of the present disclosure.

FIG. 9 shows a diagram of a system including a device that supports codebook designs for CSI reporting with sparse antenna arrays in accordance with one or more aspects of the present disclosure.

FIGS. 10 and 11 show block diagrams of devices that support codebook designs for CSI reporting with sparse antenna arrays in accordance with one or more aspects of the present disclosure.

FIG. 12 shows a block diagram of a communications manager that supports codebook designs for CSI reporting with sparse antenna arrays in accordance with one or more aspects of the present disclosure.

FIG. 13 shows a diagram of a system including a device that supports codebook designs for CSI reporting with sparse antenna arrays in accordance with one or more aspects of the present disclosure.

FIGS. 14 through 19 show flowcharts illustrating methods that support codebook designs for CSI reporting with sparse antenna arrays in accordance with one or more aspects of the present disclosure.

### DETAILED DESCRIPTION

Some wireless communications systems may support wireless communications using uniform antenna arrays (e.g., antenna arrays on a transmitting device are equidistantly spaced, such as uniform linear array (ULA)). Non-uniform (NU) antenna arrays (e.g., with unevenly spaced antennas) may provide unique benefits to a wireless communications system. Non-uniform antenna arrays may include sparse antenna arrays (e.g., nested arrays, or co-prime arrays, among other examples). Sparse antenna arrays may achieve an increased aperture and improved spatial resolution for a given number of antennas. Sparse antenna arrays may utilize fewer antennas and therefore fewer radio frequency (RF) chains, resulting in a decrease in power consumption. Sparse antenna arrays may be less affected by mutual coupling (e.g., a decreased correlation among antennas) than uniform arrays. However, precoders in some wireless communications systems may be designed based on uniform arrays, and therefore do not match non-uniform sparse antenna arrays. That is, codebooks for precoding transmissions (e.g. for a uniform array) may use discrete Fourier Transform (DFT) vectors as spatial domain (SD) bases for precoding transmissions. If DFT spatial domain bases for precoding transmissions are based on uniform arrays and assume equal spacing between antenna elements and equally spaced phases, then such DFT codebooks may not function for sparse antenna arrays. Additionally, CSI reporting for unique sparse antenna arrays may result in an increase in CSI reporting overhead, less efficient use of system resources, and increased latency.

Techniques described herein may support dedicated codebooks for sparse antenna arrays, and CSI reporting procedures with reduced overhead. Precoding matrix indicator (PMI) reporting (e.g., in a CSI report) may be based on such dedicated codebook structures. For a CSI report for sparse antenna arrays, each precoding vector for each transmission layer may be constructed from two sub-vectors. Each sub-vector may include an overlapping entry (e.g., one entry in the first sub-vector is the same as one entry in the other sub-vector). Each sub-vector may correspond to an antenna array (e.g., two concatenated uniform subarrays of a nested sparse antenna array, or two interleaved uniform subarrays of a coprime sparse antenna array, among other examples). The overlapping entry may correspond to a same antenna element in both of the two subarrays (the two concatenated or interleaved subarrays). The network may provide a UE with an indication of a sparse codebook type (e.g., co-prime or nested, etc.), and one or more parameter values for the sparse codebook type (e.g., N representing the total number of antenna elements for a nested sparse antenna array, or P and Q values for interleaving two uniform subarrays for a co-prime sparse antenna array).

The network entity may transmit CSI-RSs using the sparse antenna array. The UE may receive the CSI-RSs and perform measurements thereon. The UE may report, in the PMI of the CSI report (e.g., using the parameters indicated in the configuration information), a precoding vector for each transmission layer, each precoding vector constructed of two sub-vectors. For each sub-vector, one entry may be the same, and may correspond to a single antenna element of sparse antenna array. The network entity may utilize the PMI to precode subsequent downlink signaling, and may perform transmissions using the sparse antenna array, achieving the various benefits of spare antenna transmissions.

Aspects of the disclosure are initially described in the context of wireless communications systems. Aspects of the disclosure are further illustrated by and described with reference to wireless communications systems, sparse antenna array schemes, and process flows. Aspects of the disclosure are further illustrated by and described with reference to apparatus diagrams, system diagrams, and flowcharts that relate to codebook designs for CSI reporting with sparse antenna arrays.

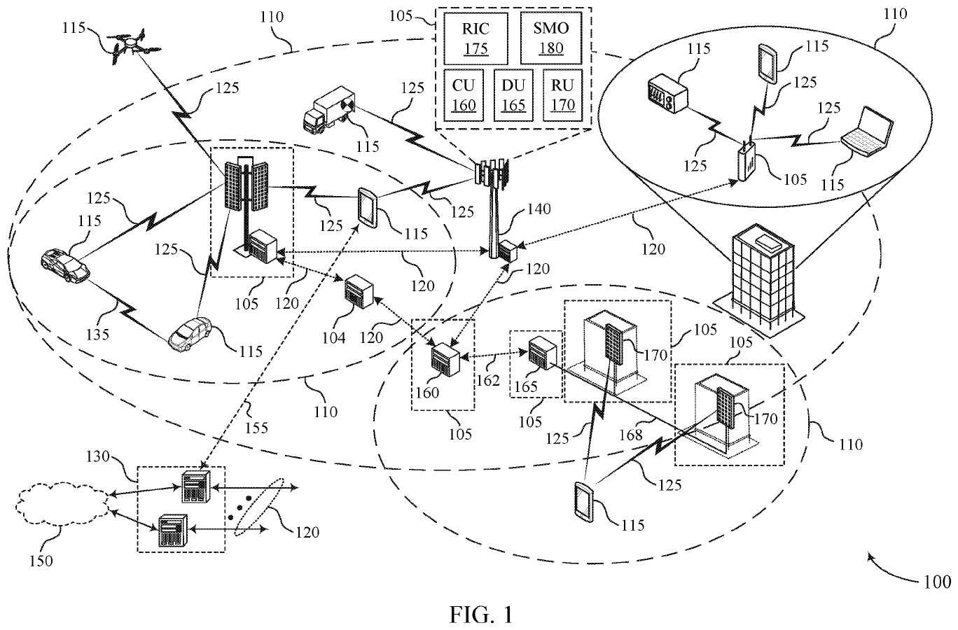

FIG. 1 illustrates an example of a wireless communications system 100 that supports codebook designs for CSI reporting with sparse antenna arrays in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support codebook designs for CSI reporting with sparse antenna arrays as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Techniques described herein may support dedicated codebooks for sparse antenna arrays, and CSI reporting procedures with reduced overhead. PMI reporting (e.g., in a CSI report) may be based on such dedicated codebook structures. For a CSI report for sparse antenna arrays, each precoding vector for each transmission layer may be constructed from two sub-vectors. Each sub-vector may include an overlapping entry (e.g., one entry in the first sub-vector is the same as one entry in the other sub-vector). Each sub-vector may correspond to an antenna array (e.g., two concatenated uniform subarrays of a nested sparse antenna array, or two interleaved uniform subarrays of a coprime sparse antenna array, among other examples). The overlapping entry may correspond to a same antenna element in both of the two subarrays (the two concatenated or interleaved subarrays). The network may provide a UE 115 with an indication of a sparse codebook type (e.g., co-prime or nested, etc.), and one or more parameter values for the sparse codebook type (e.g., N representing the total number of antenna elements for a nested sparse antenna array, or P and Q values for interleaving two uniform subarrays for a co-prime sparse antenna array).

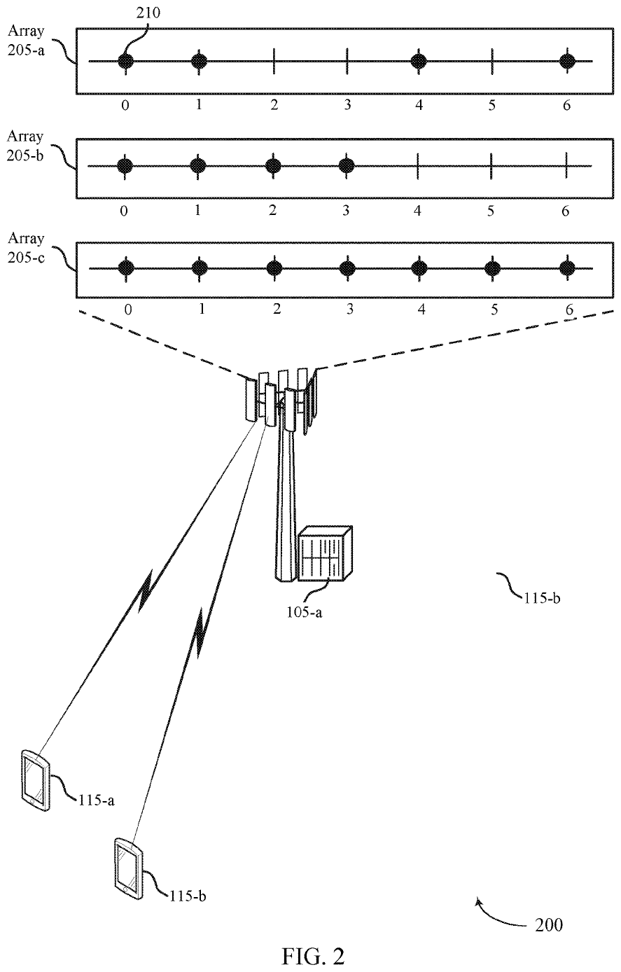

FIG. 2 illustrates an example of a wireless communications system 200 that supports codebook designs for CSI reporting with sparse antenna arrays in accordance with one or more aspects of the present disclosure. Wireless communications system 200 may implement, or be implemented by, aspects of wireless communications system 100. For example, the wireless communications system 200 may include a network entity 105-a, and one or more UEs 115 (e.g., the UE 115-a, and the UE 115-b), which may be examples of corresponding devices described with reference to FIG. 1.

The network entity 105-a may communicate with one or more UEs 115. The network entity 105-a may generate downlink signaling, including generating and steering beams, using one or more antenna panels. Each antenna panel may include one or more antenna elements (e.g., antennas 210), which may be organized into antenna arrays, such as arrays 205. The wireless communications system 200 may support multi-antenna arrays 205 and multi-antenna communications, which may improve spectral efficiency. Wireless devices (e.g., such as the network entity 105-a) may support uniform arrays 205 (e.g., such as the array 205-b and the array 205-c). Uniform arrays 205 may include one or more linear arrays where each antenna 210 is equidistantly spaced across the antenna panel. For example, array 205-c may include seven antennas 210, which may be equidistantly spaced (e.g., one antenna 210 located at each of antenna positions 0 through 6). Similarly, array 205-b may include four antenna 210, which may be equidistantly spaced (e.g., one antenna 210 located at each of antenna positions 0 through 3).

In some examples, a wireless device (e.g., the network entity 105-a) may support non-uniform arrays 205, such as the array 205-a. A non-uniform array 205 may include one or more linear arrays where each antenna 210 is unevenly spaced (e.g., the distance between various antennas 210 may not be the same). This may result in less antenna 210 configured on the array 205-a (e.g., or less active antennas 210, if some uniformly configured antenna 210 are inactive to facilitate a non-uniform array 205-a). For example, array 205-a may include four antennas 210 (e.g., a same number of antennas 210 as array 205-b). However, while the antennas 210 of array 205-b may be equidistantly spaced, the antennas 210 of non-uniform array 205-a may be unevenly spaced. For instance, the four antennas 210 may be located at antenna position 0, antenna position 1, antenna position 4, and antenna position 6. Non-uniform arrays 205 may be referred to as sparse antenna arrays. Sparse antenna arrays may include examples such as co-prime arrays, nested arrays, or other variants, as described in greater detail herein. Wireless communications using non-uniform arrays may result in a larger aperture and higher spatial resolution for a given antenna number in a sparse antenna array. For a given aperture, a sparse antenna array may include fewer antennas 210 than a uniform array, resulting in fewer radio frequency (RF) chains, and reduced power consumption. Sparse antenna arrays may be less effected by mutual coupling (MC) than uniform arrays (e.g., may experience less correlation among or between antennas 210 of the array).

A sparse antenna array may support narrower beam width than a uniform array (e.g., with the same number of antennas 210). For instance, the network entity 105-a may generate a 3 dB beamwidth (BW_{3dB}) according to equation 1:

$$B {W}_{3 d B} {=}^{△} \frac{0.886 λ}{L cos θ} \qquad Equation 1$$

where L represents an aperture for the array 205-a and λ represents a wavelength of the wireless signaling. An array factor for the beamforming or beam steering may be determined according to equation 2:

$$AF ( θ ) {=}^{△} {\sum }_{n} {e}^{j \frac{2 π}{λ} {x}_{n} cos θ} \qquad Equation 2$$

where xₙ represents a position of an n^{th} antenna 210 of the array. The network entity 105-a may generate such a beam using a uniform array (e.g., the array 205-c having seven uniformly spaced antennas 210), or using a non-uniform array (e.g., the array 205-a having four non-uniformly spaced antennas 210). The network entity 105-a may form or steer such a beam using array 205-a that is as narrow as such a beam formed or steered using array 205-c (e.g., the beam formed or steered by the array 205-a may have larger sidelobes than the beam steered or formed by the array 205-c). Thus, sparse antenna arrays may support more narrow beamwidths using less antennas 210, and consuming less power.

Sparse antenna arrays may support higher spatial resolution than similar uniform arrays. For instance, the network entity 105-a may communicate with one or more far field UEs (e.g., the UE 115-a and the UE 115-b). The UE 115-a may be located at 60 degrees and the UE 115-b may be located at 70 degrees. The network entity 105-a may form or steer beams using one or more arrays 205 to perform wireless communications with the two far field UEs 115 (e.g., based on a free space propagation channel model, using 10 samples for covariance matrix computation). In such examples, the network entity 105-a may not be able to distinguish the two spatially close UEs 115 using uniform array 205-b (e.g., which has four antennas 210). But, using the same number of antennas 210 (e.g., four antennas 210), the network entity 105-a may be able to successfully distinguish the two spatially close UEs 115 using a non-uniform array 205 (e.g., the array 205-a). Thus, with an equal number of antennas 210, a wireless device (e.g., such as the network entity 105-a) may be able to discriminate spatially close UEs 115 using a sparse antenna array (e.g., instead of a uniform array having the same number of antennas 210). For example, the spatial resolution of a four-antenna sparse antenna array (e.g., the array 205-a) may be similar to the spatial resolution of a seven-antenna uniform array 205-c.

Sparse antenna arrays may support higher spectral efficiency than similar uniform arrays. The network entity 105-a may communicate with one or more far field UEs 115 (e.g., the UE 115-a and the UE 115-b). For instance, the UE 115-a may be in the direction of 90 degrees, and the UE 115-b may be in the direction of 105 degrees. The Network entity 105-a may communicate according to a free space propagation channel mode, and may perform beamforming according to a linear phase gradient defined by equation 3:

$$Linear Gradient = {\{ \frac{1}{\sqrt{N}} {e}^{j \frac{2 π}{λ} {x}_{n} cos θ} \}}_{n = 1}^{N} \qquad Equation 3$$

with a spectral efficiency of log₂(1+SINRᵤ), where u=1,2. In such examples, noise may be a bottleneck to spectral efficiency (e.g., bits per second per Hertz (Hz)) at lower SNR ranges (e.g., spectral efficiency may be low or at 0 at low SNR ranges regardless of a type of array 205). Similarly, interference may bottleneck spectral efficiency (e.g., changes of SNR may not result in a change of spectral efficiency) at higher SNR ranges. For equal orders of diversity gain, a sparse antenna array (e.g., the array 205-a with four antennas 210) may outperform (e.g., result in a higher spectral efficiency for a given SNR) a uniform array 205 (e.g., the array 205-b with four antennas 210) because the sparse antenna array may suffer reduced inter-user or inter-layer interference due to a higher spatial resolvability. Thus, with equal aperture and spatial resolvability, a four-antenna sparse antenna array may perform better than a four-antenna uniform array.

A sparse antenna array may consume less power than a uniform array. Power consumption at a radio frequency integrated circuit (RFIC) (P_{RFIC-TX}) of a wireless device (e.g., the network entity 105-a) may be defined by equation 4:

$${P}_{RFIC - TX} = ( \frac{{P}_{o u t}}{ρ} + {P}_{1} ) N \qquad Equation 4$$

where Pₒᵤₜ represents the radiated and transmitted power, P₁ represents remaining power, ρ represents a power amplifier (PA) efficiency, and N represents a transceiver unit (TXRU) number. The network entity 105-a transmitting using a sparse antenna array (e.g., the array 205-a having four antennas 210) may experience lower power consumption in an RFIC, lower computational complexity, and less cost, than a uniform array (e.g., even a uniform array including more antennas 210, such as the array 205-c).

A sparse antenna array may be less affected by MC than some uniform arrays. Coupling leakage may occur in some uniform arrays, and may quantify the mutual coupling of an array [0,1] according to equation 5:

$$ℒ = \frac{{‖ C - diag ( C ) ‖}_{F}}{{‖ C ‖}_{F}} \qquad Equation 5$$

where C represents a mutual coupling matrix (MCM), such as a B-banded symmetric Toeplitz matrix. For instance, according to equation 6:

$${C}_{i , j} = \{ \begin{matrix}c ( \vert {x}_{i} - {x}_{j} \vert ) , \vert {x}_{i} - {x}_{j} \vert \leq B ; \\ 0 , \vert {x}_{i} - {x}_{j} \vert > B\end{matrix} \qquad Equation 6$$

$$∀ k , l > 0 , \vert \frac{c ( k )}{c ( l )} \vert = \frac{l}{k} , c ( 0 ) = 1$$

$$and$$

$$c ( 1 ) = \frac{1}{2} {e}^{0.25 j π} , c ( 2 ) = \frac{1}{4} {e}^{0.7 j π} , c ( 3 ) = \frac{1}{6} {e}^{0.7 j π} .$$

For a uniform array, the effects of mutual coupling may increase as the number of antennas 210 increases (e.g., the effects of mutual coupling may be greater for the uniform array 205-c than for the uniform array 205-b). With an equal number of antennas 210, a sparse antenna array (e.g., the sparse antenna array 205-a having four antennas 210) may suffer less mutual coupling than a uniform array (e.g., the sparse antenna array 205-b having four antennas 210).

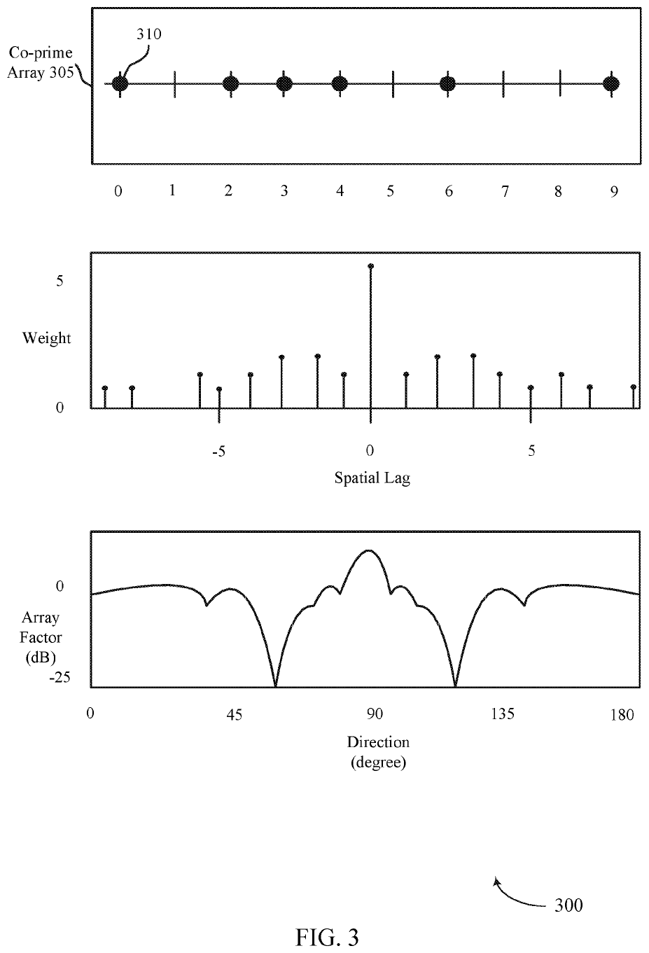

In some examples, as described herein with reference to FIGS. 3-5, a wireless device (e.g., the network entity 105-a may perform wireless communications using a sparse antenna array because, for a given number of antennas 210, sparse antenna arrays may achieve larger aperture and improved spatial resolution, may utilize fewer antennas 210 than uniform arrays, fewer RF chains, and may experience less power consumption, and may further be less affected by MC than uniform arrays. However, precoding of downlink signaling (e.g., DFT-based SD bases), and precoding matrix indicator (PMI) reporting by UEs 115, may be designed for uniform arrays, and may therefore not match non-uniform sparse antenna arrays. For example, for uniform arrays, codebooks may use DFT vectors as a spatial domain (SD) basis. To precode a downlink signal, a network entity 105-a may apply a set of weights w to various antennas 210 to generate or steer one or more beams from an array 205 according to equation 6:

$$Equation 6$$

$$[ {w}_{l , 1} , {w}_{l , 2} , … , {w}_{l , S} ] = {W}_{1} {W}_{2} = ( {I}_{2} ⊗ B ) [ \begin{matrix}{c}_{l , 1 , 1} , & {c}_{l , 2 , 1} , & … , & {c}_{l , S , 1} \\ {c}_{l , 1 , 2} , & {c}_{l , 2 , 2} , & … , & {c}_{l , S , 2}\end{matrix} ]$$

where I₂ is an identify matrix of dimension 2×2 and B represents a spatial domain basis that is an incomplete DFT basis. Elements in each column and/or component vector may represent a series of equally spaced phases.

In some examples, the network entity 105-a could puncture one or more full DFT vectors based on the layout of a sparse antenna array (e.g., could ignore entries in a precoding vector reported by a UE 115 or could transmit using the antennas 210 of a sparse antenna array regardless of PMI reported by the UE 115). However, under such circumstances, resultant vectors may not have an orthonormal basis anymore. In some examples, the network entity 105-a could use DFT vectors whose lengths equal the number of antennas in a sparse antenna array. For instance, the network entity 105-a could use a length-four DFT vector for precoding downlink signaling via the array 205-a. However, such spatial domain bases for precoding the downlink signaling may sacrifice spatial domain sparsity in the sparse antenna array. Additionally, or alternatively, such precoding may result in complete (e.g., not incomplete) basis as a spatial domain basis for the precoding matrix, which may introduce a large CSI report overhead for UEs 115 reporting PMI.

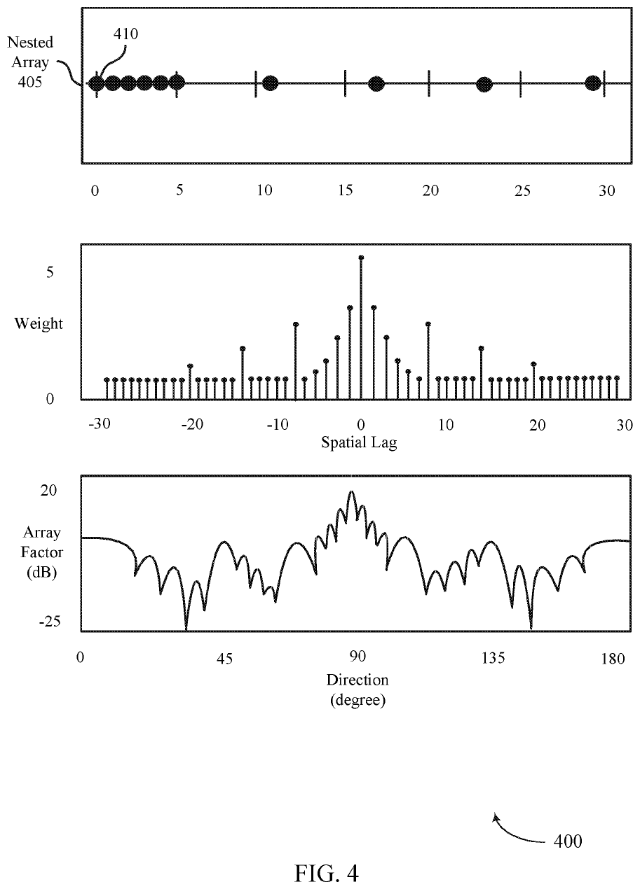

Techniques described herein may support dedicated codebook designs for sparse antenna arrays, that may be supported with low CSI reporting overhead. Sparse antenna arrays may include co-prime arrays (e.g., as described in greater detail with reference to FIG. 3) or nested arrays (e.g., as described in greater detail with reference to FIG. 4), among other examples. A new codebook structure may include features such as precoding vectors v (e.g., reported by receiving devices, such as the UEs 115) constructed by two sub-vectors v₁ and v₂. The sub-vectors may include one overlapping element (e.g., the position of the overlapping element may depend on the sparse antenna array structure, and may be associated with a single antenna element of the sparse antenna array). Each of the sub-vectors may correspond to a uniform subarray within the sparse antenna array (e.g., the sparse antenna array may be constructed of two concatenated or interleaved uniform subarrays). To support such codebooks, the network (e.g., the network entity 105-a) may configure UEs 115 with a codebook type (e.g., a codebook structure type indicating a nested codebook type or a co-prime nested type), and parameters associated with the indicated codebook type. The indicated parameters may depend on the codebook type, as described in greater detail with reference to FIGS. 3-5. The network entity 105-a may transmit CSI-RSs to a UE 115 (e.g., respective CSI-RSs from each antenna 210 in the sparse antenna array), and the UE 115 may perform measurements on the received CSI-RSs and generate a CSI report. The CSI report may include one or more precoding vectors (e.g., one precoding vector for each transmission layer). The UE 115 may report two sub-vectors v₁ and v₂ for the precoding vector v of each layer. One entry in each sub-vector may correspond to the same antenna of the sparse antenna array, and may thus have equal values. The network entity 105-a may receive the CSI report, including the reported sub-vectors according to the codebook design for sparse antenna arrays.

Although illustrated with reference to a transmitting device such as the network entity 105-a, any wireless device (e.g., a network entity 105, a UE 115, among other examples), may perform the techniques described herein or may support sparse antenna arrays. Although illustrated with reference to an array 205-a (e.g., a linear array), sparse antenna arrays may by multidimensional (e.g., including arrays or subarrays of antennas 210 in one or more rows or one or more columns).

FIG. 3 illustrates an example of a sparse antenna array scheme 300 that supports codebook designs for CSI reporting with sparse antenna arrays in accordance with one or more aspects of the present disclosure. Sparse antenna array scheme 300 may implement, or be implemented by, aspects of wireless communications system 100 and wireless communications system 200. For example, a transmitting device (e.g., a network entity 105) and a receiving device (e.g., a UE 115), which may be examples described with reference to FIG. 1 and FIG. 2, may communicate according to the sparse antenna array scheme 300.

In some examples, a transmitting device (e.g., a network entity) may perform wireless communications using a sparse antenna array. A sparse antenna array may include one or more antennas 310 across one or more antenna positions (e.g., where the distance d between antenna positions is

$$d = \frac{λ}{2} ) .$$

For a sparse antenna array, one or more antennas 310 are not uniformly spaced. For instance, the sparse antenna array may be a coprime array 305. A co-prime array 305 may include a total number of antennas (N) defined by equation 7:

$$N = 2 \cdot P + Q - 1 \qquad Equation 7$$

where P and Q are co-prime integers, and where P<Q. The co-prime array 305 may consist of two uniform arrays (e.g., two sets of antennas 310 S₁ and S₂) such that the co-prime array 305 includes a set of antennas S is defined by a union of S₁ and S₂ (e.g., S=S∪S₂).

The first uniform array may be defined based on the parameter P according to equation 8:

$${S}_{1} = \{ qP \vert q = 0 , 1 , … , Q - 1 \} \qquad Equation 8$$

Similarly, the second uniform array may be defined based on the parameter Q according to equation 9:

$${S}_{2} = \{ pQ \vert p = 0 , 1 , … , 2 P - 1 \} \qquad Equation 9$$

Thus, for P=2 and Q=3, S={0, 2, 3, 4, 6, 9}. That is, the first uniform array may include an antenna 310 located at antenna position 0, an antenna 310 located at antenna position 2, and an antenna 310 located at antenna position 4, while the second uniform array may include an antenna 310 located at antenna position 0, an antenna 310 at antenna position 3, an antenna 310 at antenna position 6, and an antenna 310 at antenna position 9. This may result in a co-prime array 305 including antennas 310 at antenna positions 0, 2, 3, 4, 6, and 9.

A co-prime array 305 may experience less mutual coupling than a uniform array. For example, a difference co-array (DCA) may be based on spatial lag (e.g., differences) generated based on using available sensors. A missing spatial lag may form a hole in the DCA, which reduces the uniform degree of freedom of the array. The co-prime array 305 may result in a close-form expression, and may be simple to generate for the network entity. Although the various weights and spatial lags resulting from co-prime array 305 may not result in an entirely hole-free DCA, the network entity may perform wireless communications with relatively low or even negligible mutual coupling. The network entity may further be able to steer relatively narrow beams using less antennas 310 than a uniform array, less power, etc. (e.g., a direction beam directed at 90 degrees with a high array factor).

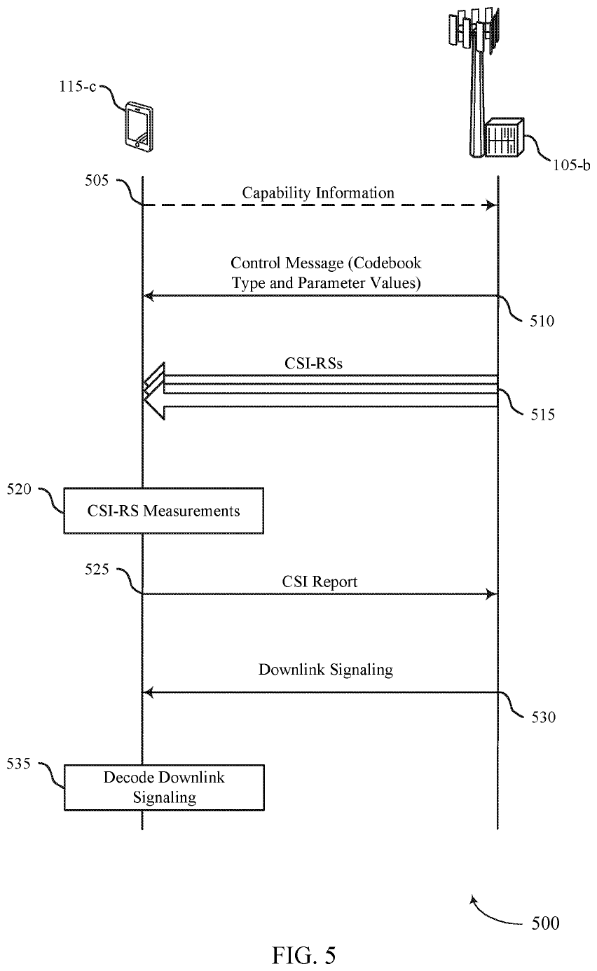

In some examples, as described herein, the network entity may configure one or more UEs with a codebook type and one or more parameters associated with the codebook type. For instance, the network entity may transmit, to the one or more UEs, an indication of a co-prime codebook type. In such examples, the network entity may further configure the UEs with co-prime parameters (e.g., P and Q). The UEs may then receive CSI-RSs transmitted using the sparse antenna array (e.g., the co-prime array 305), and may generate PMI for inclusion in the CSI report according to the indicated codebook type (e.g., co-prime codebook type) according to the co-prime parameters. As described in greater detail with reference to FIG. 5, each UE may include, in the CSI report, two sub-vectors for each transmission layer, where one entry in each sub-vector is a same value associated with a same antenna 310 (e.g., the antenna 310 located at antenna position 0 for the co-prime array 305). Although illustrated with reference to an array 305 (e.g., a linear array), sparse antenna arrays may by multidimensional (e.g., including arrays or subarrays of antennas 310 in one or more rows or one or more columns).

FIG. 4 illustrates an example of a sparse antenna array scheme 400 that supports codebook designs for CSI reporting with sparse antenna arrays in accordance with one or more aspects of the present disclosure. Sparse antenna array scheme 400 may implement, or be implemented by, aspects of wireless communications system 100 and wireless communications system 200. For example, a transmitting device (e.g., a network entity 105) and a receiving device (e.g., a UE 115), which may be examples described with reference to FIGS. 1-3, may communicate according to the sparse antenna array scheme 400.

In some examples, a transmitting device (e.g., a network entity) may perform wireless communications using a sparse antenna array. A sparse antenna array may include one or more antennas 310 across one or more antenna positions (e.g., where the distance d between antenna positions is

$$d = \frac{λ}{2} ) .$$

For a sparse antenna array, one or more antennas 410 are not uniformly spaced. For instance, the sparse antenna array may be a nested array 405. A nested array 405 may include a total number of antennas (N) defined by equation 10:

$$N = {N}_{1} + {N}_{2} \qquad Equation 10$$

where for an even number of antennas 410,

$${N}_{1} = {N}_{2} = \frac{N}{2} ,$$

and for an odd number of antennas 410,

$${N}_{1} = \frac{N - 1}{2} ,$$

$$and$$

$${N}_{2} = \frac{N + 1}{2} .$$

The nested array 405 may consist of two uniform arrays (e.g., two sets of antennas 410 S₁ and S₂) such that the nested array 405 includes a set of antennas S is defined by a union of S₁ and S₂ (e.g., S=S₁∪S₂).

The first uniform array may be defined based on the parameter N (e.g., N₁) according to equation 11:

$${S}_{1} = \{ 0 , 1 , … , {N}_{1} - 1 \} \qquad Equation 11$$

Similarly, the second uniform array may be defined based on the parameter N (e.g., N₁ and N₂) according to equation 12:

$${S}_{2} = \{ {N}_{1} + ( {N}_{1} + 1 ) i \vert i = 0 , 1 , … , {N}_{2} - 1 . \} \qquad Equation 12$$

Thus, for N=10, where N₁=N₂=5, S={0, 1, 2, 3, 4, 5, 11, 17, 23, 29}. That is, the first uniform array may include an antenna 410 located at each of antenna positions 0-5 (e.g., N₁+1=6 antennas 410), and the second uniform array may include an antenna 410 located at antenna positions 5, 11, 17, 23, and 29 (e.g., N₂=5 antennas 410). This may result in a nested array 405 including antennas 410 at antenna positions 0, 1, 2, 3, 4, 5, 11, 17, 23, and 29 (e.g., where the antenna 410 at antenna position 5 is shared by both the first uniform array and the second uniform array).

A nested array 405 may experience less mutual coupling than a uniform array. For example, a difference co-array (DCA) may be based on spatial lag (e.g., differences) generated based on using available sensors. A missing spatial lag may form a hole in the DCA. However, nested array 405 may not result any holes that would reduce the uniform degree of freedom of the array. Further, despite effects of mutual coupling (e.g., due to oversampled spatial lags), the nested array 405 may still experience less mutual coupling than a uniform array with the same aperture size or the same number of antennas. The nested array 405 may result in a close-form expression, and may be simple to generate for the network entity. The network entity may further be able to steer relatively narrow beams using less antennas 410 than a uniform array, less power, etc. (e.g., a direction beam directed at 90 degrees with a high array factor).

In some examples, as described herein, the network entity may configure one or more UEs with a codebook type and one or more parameters associated with the codebook type. For instance, the network entity may transmit, to the one or more UEs, an indication of a nested codebook type. In such examples, the network entity may further configure the UEs with nested array parameters (e.g., N, or N₁ and N₂). The UEs may then receive CSI-RSs transmitted using the sparse antenna array (e.g., the nested array 405), and may generate PMI for inclusion in the CSI report according to the indicated codebook type (e.g., nested codebook type) according to the nested array parameters. As described in greater detail with reference to FIG. 5, each UE may include, in the CSI report, two sub-vectors for each transmission layer, where one entry in each sub-vector is a same value associated with a same antenna 310 (e.g., the antenna 410 located at antenna position 5 for the nested array 405). Although illustrated with reference to an array 405 (e.g., a linear array), sparse antenna arrays may by multidimensional (e.g., including arrays or subarrays of antennas 410 in one or more rows or one or more columns).

FIG. 5 illustrates an example of a process flow 500 that supports codebook designs for CSI reporting with sparse antenna arrays in accordance with one or more aspects of the present disclosure. Process flow 500 may implement, or be implemented by, aspects of wireless communications system 100, wireless communications system 200, the sparse antenna array scheme 300, and the sparse antenna array scheme 400. For example, the UE 115-c and the network entity 105-b may be examples of corresponding devices described with reference to FIGS. 1-4.

The network entity 105-b may communicate with one or more UEs 115 (e.g., the UE 115-c) using a sparse antenna array (e.g., a nested array or a coprime array). Such communications may be based on codebook types that are defined for sparse antenna arrays. Such a structure may include one or more rules. For instance, a precoding vector in the PMI may be constructed by two spatial bases (e.g., B₁ and B₂), and two coefficient vectors (e.g., c₁ and c₂) corresponding to two componential subarrays of the sparse antenna array. For sparse antenna array codebook types described herein, one entry in sub-vector v₁=B₁·c₁, and one entry in sub-vector v₂=B₂·c₂ may correspond to a same antenna of the sparse antenna array, and may therefore have the same value. Spatial bases may be shared for all layers.

For a nested array, the sparse antenna array may be nested with N antennas (e.g., indicated via a parameter such as sparseParameter_N in the control message at 510). The sparse antenna array may include two concatenated uniform subarrays, with one antenna (e.g., antenna

$$\frac{N}{2} )$$

shared by the two subarrays. Thus, the first subarray may include

$$\frac{N}{2} + 1$$

antennas, in a set of antenna positions S₁ where

$${S}_{1} = \{ 0 , 1 , 2 , \text{…} , ⌊ \frac{N}{2} ⌋ \} .$$

The second subarray may include N/2 antennas, in a set of antenna positions S₂ where

$${S}_{2} = \{ ⌊ \frac{N}{2} ⌋ , ⌊ \frac{N}{2} ⌋ + 1 , ⌊ \frac{N}{2} ⌋ + 2 , ... , N - 1 \} .$$

For instance, as described with reference to FIG. 4, for a nested sparse antenna array with a length of 10 antennas (e.g., N=10),

$${S}_{1} = \{ 0 , 1 , 2 , 3 , 4 , 5 \} and$$

$${S}_{2} = \{ 5 , 11 , 17 , 23 , 29 \} , and$$

$$S = \{ 0 , 1 , 2 , 3 , 4 , 5 , 11 , 17 , 23 , 29 \} .$$

A coprime array may be associated with coprime integers P (e.g., indicated via a parameter such as sparseParameter_P in the control message at 510) and Q (e.g., indicated via a parameter such as SparseParameter_Q in the control message at 510). The sparse antenna array may include two interleaved uniform subarrays, with antenna 0 shared by the two subarrays. In such examples, the first subarray may include Q antennas, in a set of antenna positions S₁ where S₁={0, P, 2P, . . . , (Q−1)P}. The second subarray may include 2·P antennas, in a set of antenna positions S₂, where S₂={0, Q, 2Q, . . . , (2P−1)Q}. For instance, as described with reference to FIG. 3, for a co-prime array with a length of 6 antennas (e.g., P=2 and Q=3), S₁={0, 2, 4}, S₂={0, 3, 6, 9}, and S={0, 2, 3, 4, 6, 9}.

At 510, the UE 115-c may receive a control message (e.g., a RRC message, a DCI message, or a MAC-CE, among other examples). The network entity 105-b may transmit the control message to the UE 115-c. The control message may include an indication of a codebook type associated with a sparse antenna array at the network entity 105-b. The control message my include an indication of a co-prime codebook type (e.g., a parameter such as codebookType=sparse-Coprime), as described with reference to FIG. 3. The control message may include an indication of a nested codebook type (e.g., a parameter such as codebookType=sparse-Nested) as described with reference to FIG. 4). The control message (e.g., or a separate control message) may include an indication of one or more parameter values associated with the codebook type. For example, for a nested array, the control message may include a parameter such as sparseParameter_N. For instance, for a nested array such as nested array 405, the control message may include an indication of N=10. For a co-prime array, the control message may include indications of co-prime integers, such as parameters sparseParameter_P and sparseParameter_Q. For instance, for a co-prime array such as co-prime array 305, the control message may include an indication of P=2 and Q=3.

In some examples (e.g., at 505), the UE 115-c may transmit (e.g., and the network entity 105-b may receive) capability information which may indicate that the UE 115-c is capable of receiving downlink signaling of the codebook type associated with the sparse antenna array. The capability information may indicate that the UE 115-c supports (e.g., is capable of receiving, reading, or decoding) the indication (e.g., in the control message) of the codebook type or the parameters. For instance, the capability information may indicate that the UE 115-c is capable of reading or receiving a particular indication of field in a DCI message, or capable of reading or receiving a particular RRC parameter (e.g., indicating the codebook type and parameter values). In some examples, the capability information may indicate that the UE 115-c supports a new codebook structure (e.g., for the sparse antenna codebook types). The capability information may indicate that the UE 115-c is capable of representing precoding vectors (e.g., using sub-vectors) using the new codebook structure, for sparse antenna arrays.

At 515, the UE 115-c may receive one or more CSI-RSs. The network entity 105-b may transmit the CSI-RSs using the sparse antenna array.

At 520, the UE 115-c may perform CSI-RS measurements on the received CSI-RSs. The UE 115-c may generate CSI for a CSI report. The UE 115-c may also generate PMI for the CSI report. Based on the received respective CSI-RSs received from each antenna in the sparse antenna array, the UE 115-c may report two sub-vectors (e.g., v₁ and v₂) for a precoding vector (e.g., v) of each layer. One entry in vₜ and one entry in v₂ may correspond to a same antenna in the sparse antenna array, and may therefore have the same value (e.g., be the same).

The UE 115-c may generate one or more per-layer precoding vectors v, where v=[a₀, a₁, . . . , a_{N-1}]^{T} based on an singular value decomposition (SVD) of the estimated channel matrix. For example, for a nested array, the first sub-vector may correspond to a first subarray of the nested array:

$${v}_{1} = {[ {a}_{0} , {a}_{1} , ... , {a}_{⌊ \frac{N}{2} ⌋} ]}^{T} .$$

The second sub-vector may correspond to a second subarray of the nested array:

$${v}_{2} = {[ {a}_{⌊ \frac{N}{2} ⌋} , {a}_{⌊ \frac{N}{2} ⌋ + 1} , ... , {a}_{N - 1} ]}^{T} .$$

In such examples (e.g., for a nested array with N=10),

$${v}_{1} = {[ {a}_{0} , {a}_{1} , {a}_{2} , {a}_{3} , {a}_{4} , {a}_{5} ]}^{T} ,$$

$${v}_{2} = {[ {a}_{5} , {a}_{6} , {a}_{7} , {a}_{8} , {a}_{9} ]}^{T} , and$$

$$v = {[ {a}_{0} , {a}_{1} , {a}_{2} , {a}_{3} , {a}_{4} , {a}_{5} , {a}_{6} , {a}_{7} , {a}_{8} , {a}_{9} ]}^{T} .$$

For a co-prime array, the UE 115-c may generate two mapping tables for a first subarray and a second subarray of the co-prime array. The two mapping tables may be based on the configured parameters P (e.g., sparseParameter_P) and Q (e.g., sparseParameter_Q). In such examples, the first mapping table (e.g., mapping table 1) may be defined as [i₁, i₂, . . . , i_{Q}], where i_{q} represents the position of a q^{th} entry of v₁ in v, where q=1, 2, . . . , Q. The second mapping table (e.g., mapping table 2) may be defined as [j₁,j₂, . . . ,j_{2P}], where jₚ represents the position of a p^{th} entry in v₂, where p=1,2, . . . ,2P, and where i₁=j₁=0. The first sub-vector may correspond to the first subarray of the co-prime array:

$${v}_{1} = {[ {a}_{{i}_{1}} , {a}_{{i}_{2}} , ... , {a}_{{i}_{Q}} ]}^{T} .$$

The second sub-vector may correspond to the second subarray of the co-prime array: v₂=[aⱼ_{₁}, aⱼ_{₂}, . . . , aⱼ_{_{P2}}]^{T}. In such examples (e.g., for a co-prime array with P=2 and Q=3), v₁=[a₀, a₁, a₃]^{T}, v₂=[a₀, a₂, a₄, a₅]^{T}, and v=[a₀, a₁, a₂, a₃, a₄, a₅]^{T}.

In some examples, to generate two sub-vectors that are coherent, the overlapping values (e.g., one element in each sub-vector corresponding to the same antenna element) in the two sub-vectors v₁ and v₂ may be equal. However, due to limited quantization bits for some codebooks (e.g., type 2 codebooks or enhanced type 2 codebooks), the UE 115-c may not be able to generate one value in each of the two sub-vectors v₁ and v₂ that are equal to each other. In some examples, the UE 115-c may multiple a coefficient with v₁ or v₂ when composing v₁ and V₂ to ensure that the two values (e.g., one in each of v₁ and v₂) are equal.

The UE 115-c may apply a coefficient to one of v₁ or v₂. When the UE 115-c reports v₁ and v₂ respectively (e.g., based on type 2 or enhanced type 2 codebooks), the UE 115-c and the network entity 105-b may determine that the composite precoding vector is constructed by

$$\{ {v}_{1} , \frac{x}{y} {v}_{2} \} or \{ \frac{y}{x} {v}_{1} , {v}_{2} \} ,$$

where x represents the entry value of the shared antenna in v₁, and y represents the entry value of the shared antenna in v₂. Whether the UE 115-c applies such a coefficient to v₁ or v₂ based on one or more rules (e.g., in one or more standards documents), or based on configuration information received from the network entity 105-b. The UE 115-c may report CQI together with v₁ and v₂. In such examples, the CQI may be based on the precoding vector constructed with

$$\{ {v}_{1} , \frac{x}{y} {v}_{2} \} or \{ \frac{y}{x} {v}_{1} , {v}_{2} \} .$$

The network entity 105-b may use the reported CQI (e.g., for generating downlink signaling at 530 based on the CSI report), and may apply the precoding vector constructed with

$$\{ {v}_{1} , \frac{x}{y} {v}_{2} \} or \{ \frac{y}{x} {v}_{1} , {v}_{2} \} .$$

For example, a nested array with N=10 may be constructed by

$$\{ {v}_{1} , \frac{x}{y} {v}_{2} \} ,$$

such that

$${v}_{1} = {[ {a}_{11} , {a}_{12} , {a}_{13} , {a}_{14} , {a}_{15} , {a}_{16} ]}^{T} ,$$

$${v}_{2} = {[ {a}_{21} , {a}_{22} , {a}_{23} , {a}_{24} , {a}_{25} ]}^{T} , and \frac{x}{y} = \frac{{a}_{16}}{{a}_{21}} ,$$

resulting in

$$v = {[ {a}_{11} , {a}_{12} , {a}_{13} , {a}_{14} , {a}_{15} , {a}_{16} , \frac{{a}_{16}}{{a}_{21}} {a}_{22} , \frac{{a}_{16}}{{a}_{21}} {a}_{23} , \frac{{a}_{16}}{{a}_{21}} {a}_{24} , \frac{{a}_{16}}{{a}_{21}} {a}_{25} ]}^{T} .$$

A co-prime array with P=2 and Q=3 may be constructed by

$$\{ {v}_{1} , \frac{x}{y} {v}_{2} \} ,$$

such that: v₁=[a₁₁, a₁₂, a₁₃]^{T}, v₂=[a₂₁, a₂₂, a₂₃, a₂₄]^{T}, and

$$\frac{x}{y} = \frac{{a}_{11}}{{a}_{21}} ,$$

resulting in

$$v = {[ {a}_{11} , {a}_{12} , \frac{{a}_{11}}{{a}_{21}} {a}_{22} , {a}_{13} , \frac{{a}_{11}}{{a}_{21}} {a}_{23} , \frac{{a}_{11}}{{a}_{21}} {a}_{24} ]}^{T} .$$

Therefore, as described herein, the UE 115-c and the network entity 105-b may communicate with each other according to the following procedure. The network entity 105-b may be equipped with a one dimensional (1-D) nested array with length N=10. The network entity may signal (e.g., at 510) a type or structure of a codebook (e.g., codebookType=sparse-Nested) and a parameter value associated with the sparse antenna array (e.g., sparseParameter_N=10). Based on the configured 10-port CSI-RS (e.g., received at 515), the UE 115-c may perform channel estimation (e.g., at 520) and obtain a precoding vector v=[a₀, a₁, . . . , a₉]^{T} to report to the network entity 105-b. The UE 115-c may generate 2 sub-vectors (e.g., according to one or more rules and the codebook structure described herein): v₁=[a₀, a₁, . . . , a₅]^{T} ∈ [symbol] , v₂=[a₅, a₆, . . . , a₉]^{T} ∈ [symbol] . Based on the sub-vector vₘ, the UE 115-c may select a best or preferred spatial bass Bₘ from configured candidates {B_{m,1}, B_{m,2}, . . . }, m=1,2. The UE 115-c may project the sub-vector vₘ onto the spatial basis Bₘ (e.g., vₘ=Bₘcₘ), where cₘ is the coefficient vector. The UE 115-c may quantize and report B₁, B₂, c₁, and c₂ to the network entity 105-b (e.g., may report codebooks such as type 2 or enhanced type 2 codebooks, or other codebook types).

The network entity 105-b may be equipped with a one dimensional (1-D) co-prime array (e.g., with P=2 and Q=3). The network entity 105-b may signal a type or structure of a codebook (e.g., codebookType=sparse-Coprime) and a parameter value associated with the sparse antenna array (e.g., sparseParameter_P=2 and sparseParameter_Q=3). Based on the configured 6-port CSI-RSs (e.g., received at 515) the UE 115-c may perform channel estimation (e.g., at 520) and may obtain a precoding vector v=[a₀, a₁, . . . , a₅]^{T} to report to the network entity 105-b. The UE 115-c may generate two sub-vectors: v₁=[a₀, a₁, a₃]^{T}∈ [symbol] , v₂=[a₀, a₂, a₄, a₅]^{T}∈ [symbol] . Based on the sub-vector vₘ, the UE 115-c may select a best or preferred spatial basis Bₘ from the configured candidates {B_{m,1}, B_{m,2}, . . . }, m=1,2. The UE 115-c may project a sub-vector vₘ onto spatial basis Bₘ (e.g., vₘ=Bₘ·cₘ, where cₘ represents the coefficient vector. The UE 115-c may quantize and report B₁, B₂, c₁, and c₂ to the network entity 105-b (e.g., may report codebooks such as type 2 or enhanced type 2 codebooks, or other codebook types).

At 525, the UE 115-c may transmit the CSI report. The CSI report may include a PMI report based on the measurements performed at 520. PMI reporting for the sparse antenna array may be based on the structure of the codebook (e.g., a codebook unique to sparse antenna arrays).

Techniques described herein may result in one or more advantages. For example, wireless devices may perform wireless communications using the codebooks described herein (e.g., using a free space propagation with a single-antenna UE). For instance, the UE may use spatial bases as described herein, such as v₁=B_{DFT-6}c₁, v₂=B_{DFT-5}c₂ (e.g., instead of a uniform DFT basis such as v=B_{DFT-10}c) for a nested array with 10 antennas. Variation of captured power may be defined as a ratio of reported coefficients. Compared to a codebook for uniform arrays, codebooks for sparse antenna arrays may yield sparser projecting coefficients, which may reduce overhead for CSI feedback while taking advantage of the described benefits resulting from sparse antenna arrays.

At 530, the UE 115-c may receive (e.g., from the network entity 105-b) a downlink transmission. The network entity 105-b may precode the downlink signaling according to the CSI report. For example, the network entity 105-b may precode a downlink transmission based at least in part on the first sub-vector according to a first uniform arrangement corresponding to the first subset of antennas and the second sub-vector according to a second uniform arrangement corresponding to the second subset of antennas (e.g., where the sparse antenna array includes a concatenation of the first uniform arrangement and the second uniform arrangement). In some examples, the network entity 105-b may precode the downlink transmission based on the first sub-vector according to a first uniform arrangement corresponding to the first subset of antennas and the second sub-vector according to a second uniform arrangement corresponding to the second subset of antennas (e.g., where the sparse antenna array includes an interleaving of the first uniform arrangement and the second uniform arrangement). At 535, the UE 115-c may decode the downlink signaling received at 530 (e.g., according to the reported precoding vector and the precoding performed by the network entity 105-b at 530).

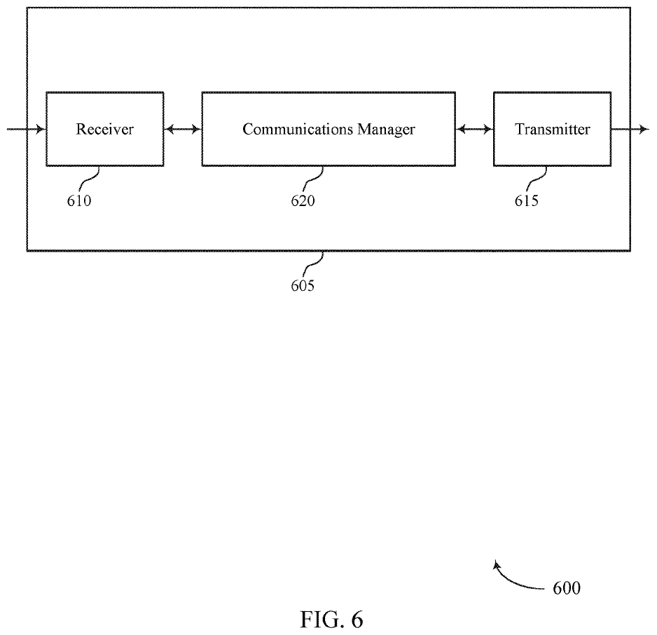

FIG. 6 shows a block diagram 600 of a device 605 that supports codebook designs for CSI reporting with sparse antenna arrays in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to codebook designs for CSI reporting with sparse antenna arrays). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to codebook designs for CSI reporting with sparse antenna arrays). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of codebook designs for CSI reporting with sparse antenna arrays as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for receiving a control message including an indication of a codebook type associated with a sparse antenna array at a network entity, and one or more parameter values associated with the codebook type. The communications manager 620 may be configured as or otherwise support a means for receiving one or more CSI-RSs according to the codebook type. The communications manager 620 may be configured as or otherwise support a means for transmitting a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for sparse array communications resulting in more reliable wireless communications (e.g., resulting from improved spatial resolution and reduced MC), reduced latency, and improved user experience.

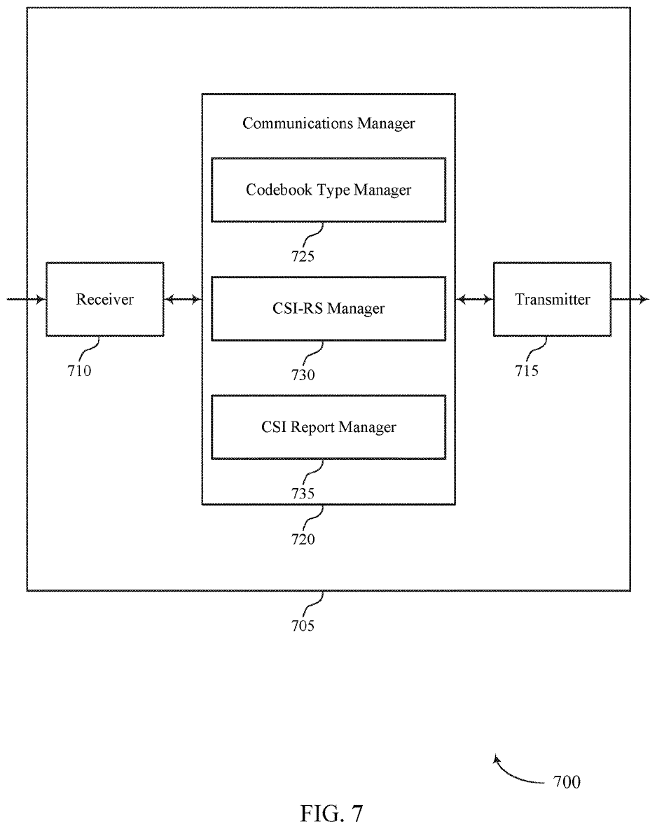

FIG. 7 shows a block diagram 700 of a device 705 that supports codebook designs for CSI reporting with sparse antenna arrays in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to codebook designs for CSI reporting with sparse antenna arrays). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to codebook designs for CSI reporting with sparse antenna arrays). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of codebook designs for CSI reporting with sparse antenna arrays as described herein. For example, the communications manager 720 may include a codebook type manager 725, a CSI-RS manager 730, a CSI report manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The codebook type manager 725 may be configured as or otherwise support a means for receiving a control message including an indication of a codebook type associated with a sparse antenna array at a network entity, and one or more parameter values associated with the codebook type. The CSI-RS manager 730 may be configured as or otherwise support a means for receiving one or more CSI-RSs according to the codebook type. The CSI report manager 735 may be configured as or otherwise support a means for transmitting a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry.

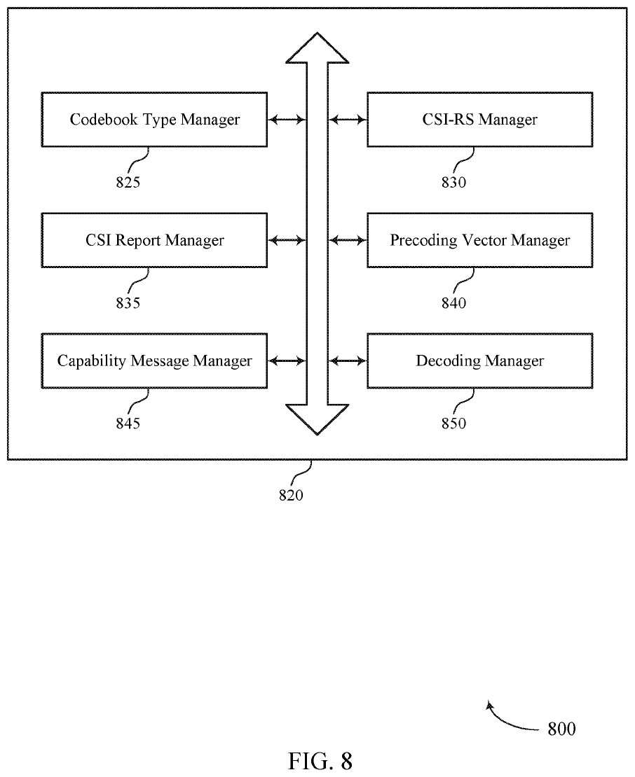

FIG. 8 shows a block diagram 800 of a communications manager 820 that supports codebook designs for CSI reporting with sparse antenna arrays in accordance with one or more aspects of the present disclosure. The communications manager 820 may be an example of aspects of a communications manager 620, a communications manager 720, or both, as described herein. The communications manager 820, or various components thereof, may be an example of means for performing various aspects of codebook designs for CSI reporting with sparse antenna arrays as described herein. For example, the communications manager 820 may include a codebook type manager 825, a CSI-RS manager 830, a CSI report manager 835, a precoding vector manager 840, a capability message manager 845, a decoding manager 850, or any combination thereof. Each of these components may communicate, directly or indirectly, with one another (e.g., via one or more buses).

The communications manager 820 may support wireless communications at a UE in accordance with examples as disclosed herein. The codebook type manager 825 may be configured as or otherwise support a means for receiving a control message including an indication of a codebook type associated with a sparse antenna array at a network entity, and one or more parameter values associated with the codebook type. The CSI-RS manager 830 may be configured as or otherwise support a means for receiving one or more CSI-RSs according to the codebook type. The CSI report manager 835 may be configured as or otherwise support a means for transmitting a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry.

In some examples, to support transmitting the CSI report, the precoding vector manager 840 may be configured as or otherwise support a means for generating the first sub-vector according to a first uniform arrangement corresponding to the first subset of antennas and the second sub-vector according to a second uniform arrangement corresponding to the second subset of antennas, and where the sparse antenna array includes a concatenation of the first uniform arrangement and the second uniform arrangement. In some examples, the one or more parameter values include a parameter value indicating a total number of antenna elements in the sparse antenna array. In some examples, the concatenation is based on the parameter value indicating the total number of antenna elements.

In some examples, to support transmitting the CSI report, the precoding vector manager 840 may be configured as or otherwise support a means for generating the first sub-vector according to a first uniform arrangement corresponding to the first subset of antennas and the second sub-vector according to a second uniform arrangement corresponding to the second subset of antennas, and where the sparse antenna array includes an interleaving of the first uniform arrangement and the second uniform arrangement. In some examples, the one or more parameter values include a first co-prime integer value and a second co-prime integer value. In some examples, the interleaving is based on the first co-prime integer value and the second co-prime integer value.

In some examples, the capability message manager 845 may be configured as or otherwise support a means for transmitting a capability message indicating that the UE is capable of receiving downlink signaling via the codebook type associated with the sparse antenna array, where receiving the control message is based on transmitting the capability message. In some examples, the at least one common entry shared between the first sub-vector and the second sub-vector corresponds to a same antenna element of the sparse antenna array.

In some examples, the decoding manager 850 may be configured as or otherwise support a means for receiving, based on transmitting the CSI report, a downlink transmission. In some examples, the decoding manager 850 may be configured as or otherwise support a means for decoding the downlink transmission based on the first precoding vector.

In some examples, the first precoding vector is one of a set of multiple precoding vectors, each of the set of multiple precoding vectors corresponding to a respective transmission layer of a set of multiple transmission layers. In some examples, the sparse antenna array includes a set of multiple antenna elements that are unevenly spaced with reference to each other on an antenna panel of the network entity.

In some examples, to support receiving the control message, the codebook type manager 825 may be configured as or otherwise support a means for receiving a DCI message, a RRC message, a MAC-CE, or any combination thereof.

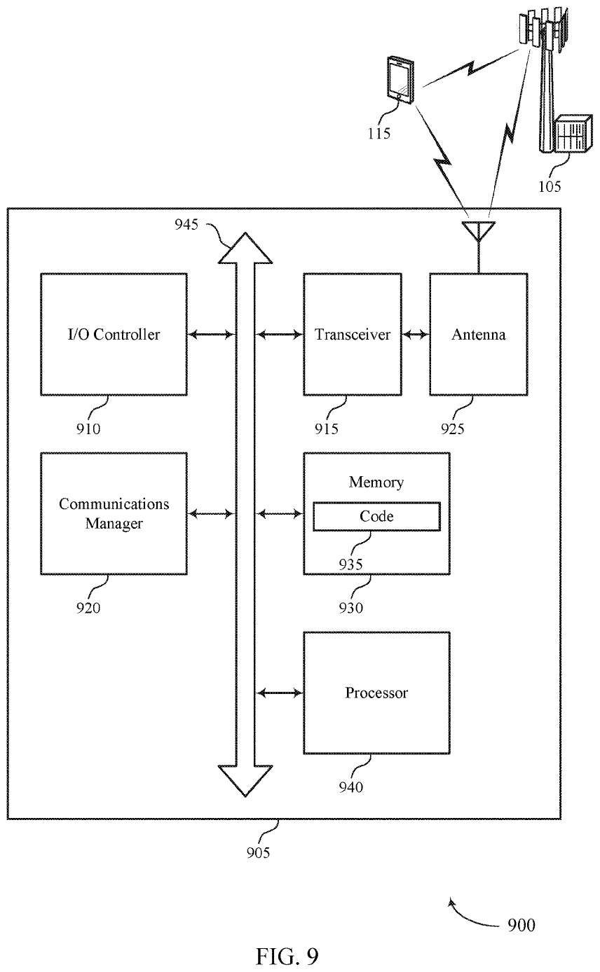

FIG. 9 shows a diagram of a system 900 including a device 905 that supports codebook designs for CSI reporting with sparse antenna arrays in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting codebook designs for CSI reporting with sparse antenna arrays). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving a control message including an indication of a codebook type associated with a sparse antenna array at a network entity, and one or more parameter values associated with the codebook type. The communications manager 920 may be configured as or otherwise support a means for receiving one or more CSI-RSs according to the codebook type. The communications manager 920 may be configured as or otherwise support a means for transmitting a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry.

By including or configuring the communications manager 920 in accordance with examples as described herein, the device 905 may support techniques for sparse array communications resulting in more reliable wireless communications (e.g., resulting from improved spatial resolution and mutual coupling), decreased system latency, and improved user experience.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of codebook designs for CSI reporting with sparse antenna arrays as described herein, or the processor 940 and the memory 930 may be otherwise configured to perform or support such operations.

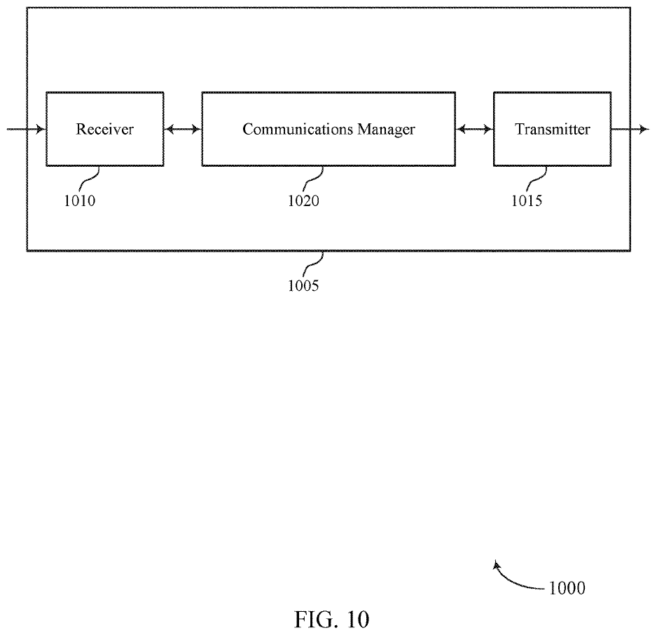

FIG. 10 shows a block diagram 1000 of a device 1005 that supports codebook designs for CSI reporting with sparse antenna arrays in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of codebook designs for CSI reporting with sparse antenna arrays as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for outputting a control message including an indication of a codebook type associated with a sparse antenna array at the network entity, and one or more parameter values associated with the codebook type. The communications manager 1020 may be configured as or otherwise support a means for outputting one or more CSI-RSs according to the codebook type. The communications manager 1020 may be configured as or otherwise support a means for obtaining a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for wireless communications using a sparse antenna array, resulting in decreased power consumption, decreased MC, improved spatial resolution, improved directional signaling to receiving devices, more reliable communications, and improved user experience.

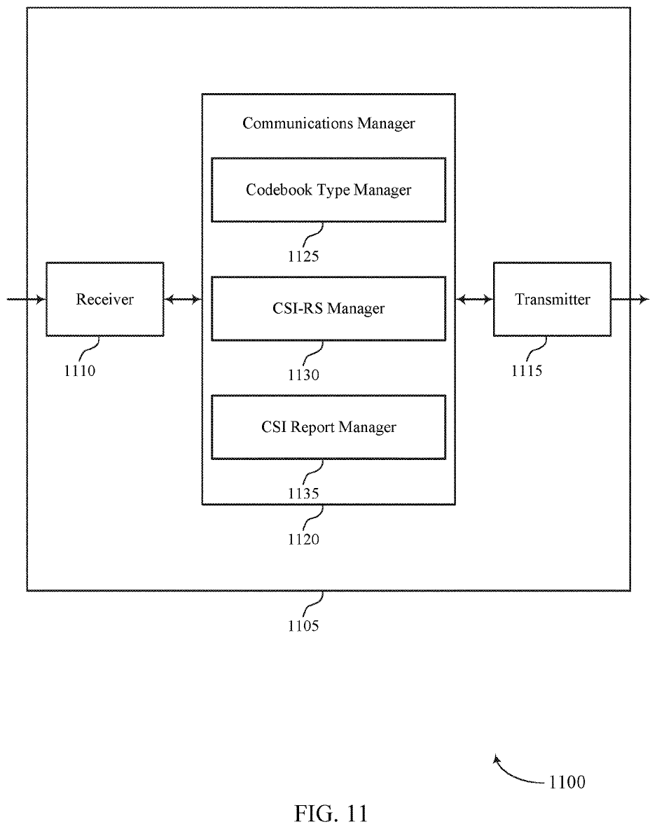

FIG. 11 shows a block diagram 1100 of a device 1105 that supports codebook designs for CSI reporting with sparse antenna arrays in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of codebook designs for CSI reporting with sparse antenna arrays as described herein. For example, the communications manager 1120 may include a codebook type manager 1125, a CSI-RS manager 1130, a CSI report manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The codebook type manager 1125 may be configured as or otherwise support a means for outputting a control message including an indication of a codebook type associated with a sparse antenna array at the network entity, and one or more parameter values associated with the codebook type. The CSI-RS manager 1130 may be configured as or otherwise support a means for outputting one or more CSI-RSs according to the codebook type. The CSI report manager 1135 may be configured as or otherwise support a means for obtaining a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry.

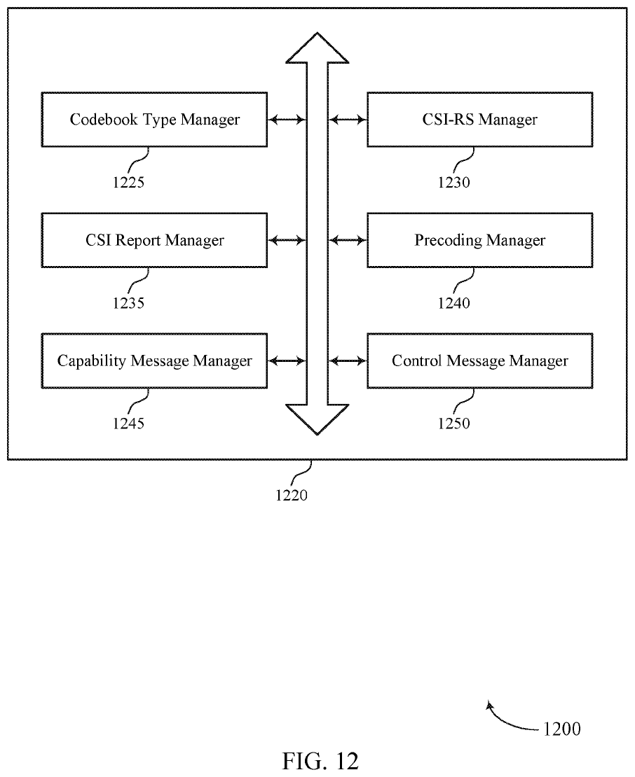

FIG. 12 shows a block diagram 1200 of a communications manager 1220 that supports codebook designs for CSI reporting with sparse antenna arrays in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of codebook designs for CSI reporting with sparse antenna arrays as described herein. For example, the communications manager 1220 may include a codebook type manager 1225, a CSI-RS manager 1230, a CSI report manager 1235, a precoding manager 1240, a capability message manager 1245, a control message manager 1250, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The codebook type manager 1225 may be configured as or otherwise support a means for outputting a control message including an indication of a codebook type associated with a sparse antenna array at the network entity, and one or more parameter values associated with the codebook type. The CSI-RS manager 1230 may be configured as or otherwise support a means for outputting one or more CSI-RSs according to the codebook type. The CSI report manager 1235 may be configured as or otherwise support a means for obtaining a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry.

In some examples, the precoding manager 1240 may be configured as or otherwise support a means for precoding a downlink transmission based on the first sub-vector according to a first uniform arrangement corresponding to the first subset of antennas and the second sub-vector according to a second uniform arrangement corresponding to the second subset of antennas, where the sparse antenna array includes a concatenation of the first uniform arrangement and the second uniform arrangement. In some examples, the precoding manager 1240 may be configured as or otherwise support a means for outputting the downlink transmission based on the precoding.

In some examples, the one or more parameter values include a parameter value indicating a total number of antenna elements in the sparse antenna array. In some examples, the concatenation is based on the parameter value indicating the total number of antenna elements.

In some examples, the precoding manager 1240 may be configured as or otherwise support a means for precoding a downlink transmission based on the first sub-vector according to a first uniform arrangement corresponding to the first subset of antennas and the second sub-vector according to a second uniform arrangement corresponding to the second subset of antennas, where the sparse antenna array includes an interleaving of the first uniform arrangement and the second uniform arrangement. In some examples, the precoding manager 1240 may be configured as or otherwise support a means for outputting the downlink transmission based on the precoding.

In some examples, the one or more parameter values include a first co-prime integer value and a second co-prime integer value. In some examples, the interleaving is based on the first co-prime integer value and the second co-prime integer value.

In some examples, the capability message manager 1245 may be configured as or otherwise support a means for obtaining a capability message indicating that a UE is capable of receiving downlink signaling via the codebook type associated with the sparse antenna array, where outputting the control message is based on obtaining the capability message.

In some examples, the at least one common entry shared between the first sub-vector and the second sub-vector correspond to a same antenna element of the sparse antenna array. In some examples, the first precoding vector is one of a set of multiple precoding vectors, each of the set of multiple precoding vectors corresponding to a respective transmission layer of a set of multiple transmission layers. In some examples, the sparse antenna array includes a set of multiple antenna elements that are unevenly spaced with reference to each other on an antenna panel of the network entity.

In some examples, to support outputting the control message, the control message manager 1250 may be configured as or otherwise support a means for outputting a DCI message, a RRC message, a MAC-CE, or any combination thereof.

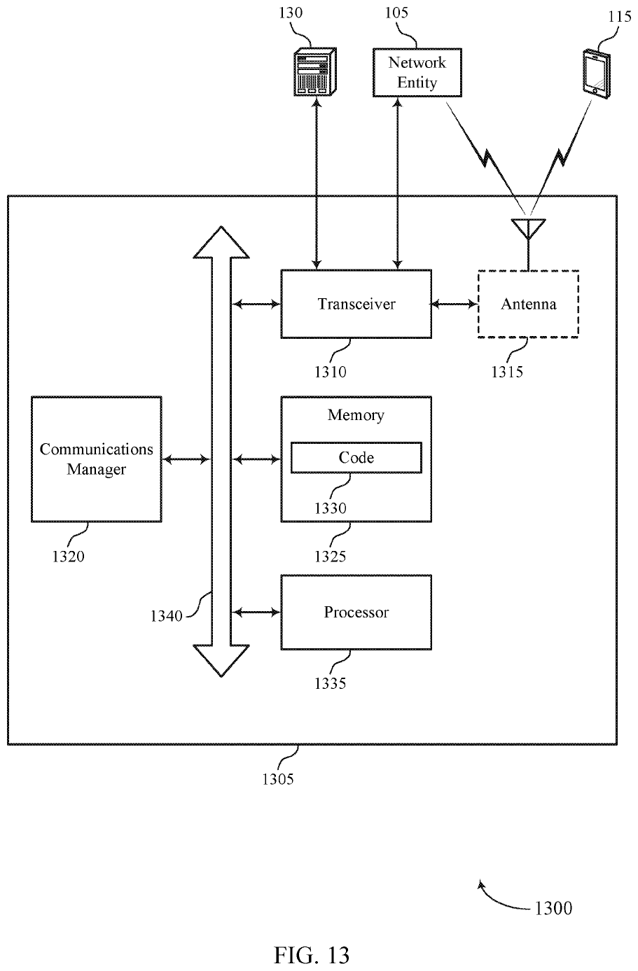

FIG. 13 shows a diagram of a system 1300 including a device 1305 that supports codebook designs for CSI reporting with sparse antenna arrays in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting codebook designs for CSI reporting with sparse antenna arrays). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for outputting a control message including an indication of a codebook type associated with a sparse antenna array at the network entity, and one or more parameter values associated with the codebook type. The communications manager 1320 may be configured as or otherwise support a means for outputting one or more CSI-RSs according to the codebook type. The communications manager 1320 may be configured as or otherwise support a means for obtaining a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry.

By including or configuring the communications manager 1320 in accordance with examples as described herein, the device 1305 may support techniques for wireless communications using a sparse antenna array, resulting in decreased power consumption, decreased MC, improved spatial resolution, improved directional signaling to receiving devices, more reliable communications, and improved user experience.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of codebook designs for CSI reporting with sparse antenna arrays as described herein, or the processor 1335 and the memory 1325 may be otherwise configured to perform or support such operations.

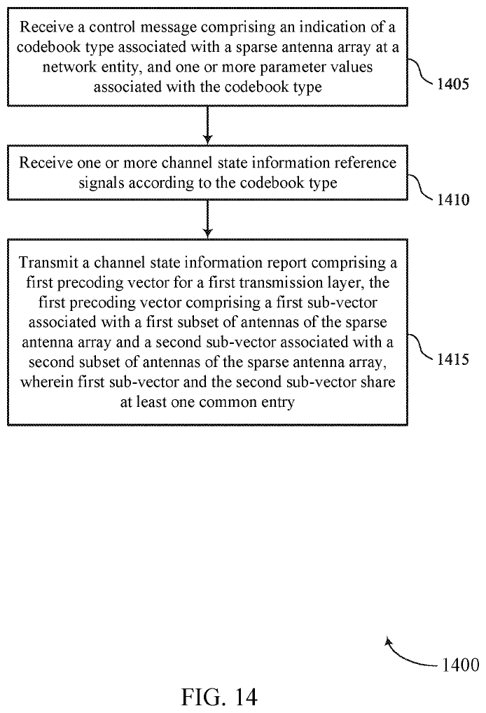

FIG. 14 shows a flowchart illustrating a method 1400 that supports codebook designs for CSI reporting with sparse antenna arrays in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a control message including an indication of a codebook type associated with a sparse antenna array at a network entity, and one or more parameter values associated with the codebook type. The operations of 1405 may be performed in accordance with examples as disclosed herein. In some examples, aspects of the operations of 1405 may be performed by a codebook type manager 825 as described with reference to FIG. 8.

At 1410, the method may include receiving one or more CSI-RSs according to the codebook type. The operations of 1410 may be performed in accordance with examples as disclosed herein. In some examples, aspects of the operations of 1410 may be performed by a CSI-RS manager 830 as described with reference to FIG. 8.

At 1415, the method may include transmitting a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry. The operations of 1415 may be performed in accordance with examples as disclosed herein. In some examples, aspects of the operations of 1415 may be performed by a CSI report manager 835 as described with reference to FIG. 8.

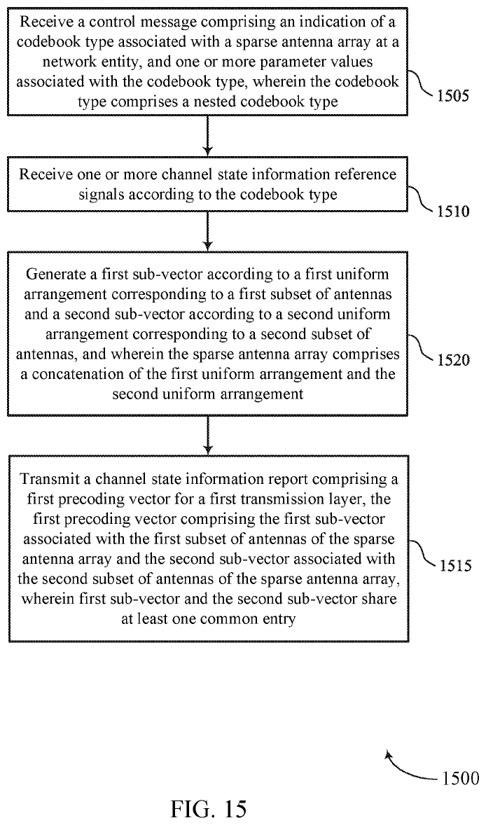

FIG. 15 shows a flowchart illustrating a method 1500 that supports codebook designs for CSI reporting with sparse antenna arrays in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a control message including an indication of a codebook type associated with a sparse antenna array at a network entity, and one or more parameter values associated with the codebook type, wherein the codebook type comprises a nested codebook type. The operations of 1505 may be performed in accordance with examples as disclosed herein. In some examples, aspects of the operations of 1505 may be performed by a codebook type manager 825 as described with reference to FIG. 8.

At 1510, the method may include receiving one or more CSI-RSs according to the codebook type. The operations of 1510 may be performed in accordance with examples as disclosed herein. In some examples, aspects of the operations of 1510 may be performed by a CSI-RS manager 830 as described with reference to FIG. 8.

At 1515, the method may include generating a first sub-vector according to a first uniform arrangement corresponding to a first subset of antennas and a second sub-vector according to a second uniform arrangement corresponding to a second subset of antennas, and wherein the sparse antenna array comprises a concatenation of the first uniform arrangement and the second uniform arrangement. The operations of 1515 may be performed in accordance with examples as disclosed herein. In some examples, aspects of the operations of 1515 may be performed by a precoding vector manager 840 as described with reference to FIG. 8.

At 1520, the method may include transmitting a CSI report comprising a first precoding vector for a first transmission layer, the first precoding vector comprising the first sub-vector associated with the first subset of antennas of the sparse antenna array and the second sub-vector associated with the second subset of antennas of the sparse antenna array, wherein the first sub-vector and the second sub-vector share at least one common entry. The operations of 1520 may be performed in accordance with examples as disclosed herein. In some examples, aspects of the operations of 1520 may be performed by a CSI report manager 835 as described with reference to FIG. 8.

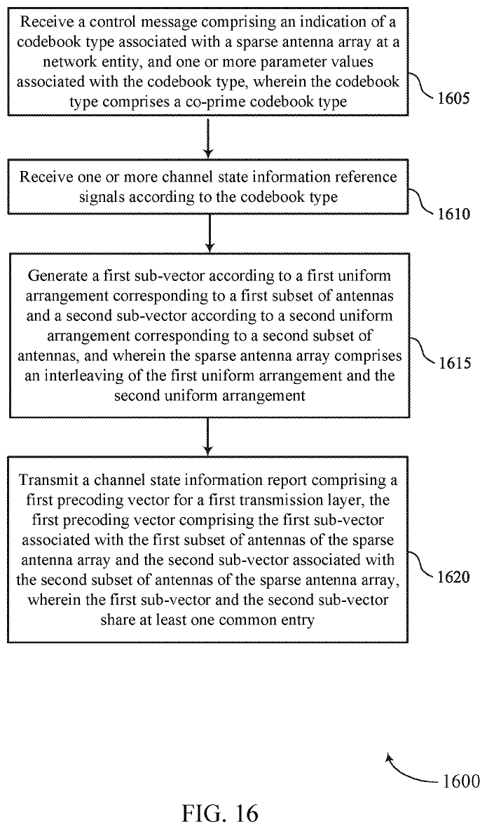

FIG. 16 shows a flowchart illustrating a method 1600 that supports codebook designs for CSI reporting with sparse antenna arrays in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving a control message including an indication of a codebook type associated with a sparse antenna array at a network entity, and one or more parameter values associated with the codebook type, wherein the codebook type comprises a co-prime codebook type. The operations of 1605 may be performed in accordance with examples as disclosed herein. In some examples, aspects of the operations of 1605 may be performed by a codebook type manager 825 as described with reference to FIG. 8.

At 1610, the method may include receiving one or more CSI-RSs according to the codebook type. The operations of 1610 may be performed in accordance with examples as disclosed herein. In some examples, aspects of the operations of 1610 may be performed by a CSI-RS manager 830 as described with reference to FIG. 8.

At 1615, the method may include generating a first sub-vector according to a first uniform arrangement corresponding to a first subset of antennas and a second sub-vector according to a second uniform arrangement corresponding to a second subset of antennas, and wherein the sparse antenna array comprises an interleaving of the first uniform arrangement and the second uniform arrangement. The operations of 1615 may be performed in accordance with examples as disclosed herein. In some examples, aspects of the operations of 1615 may be performed by a precoding vector manager 840 as described with reference to FIG. 8.

At 1620, the method may include transmitting a CSI report comprising a first precoding vector for a first transmission layer, the first precoding vector comprising the first sub-vector associated with the first subset of antennas of the sparse antenna array and the second sub-vector associated with the second subset of antennas of the sparse antenna array, wherein the first sub-vector and the second sub-vector share at least one common entry. The operations of 1620 may be performed in accordance with examples as disclosed herein. In some examples, aspects of the operations of 1620 may be performed by a CSI report manager 835 as described with reference to FIG. 8.

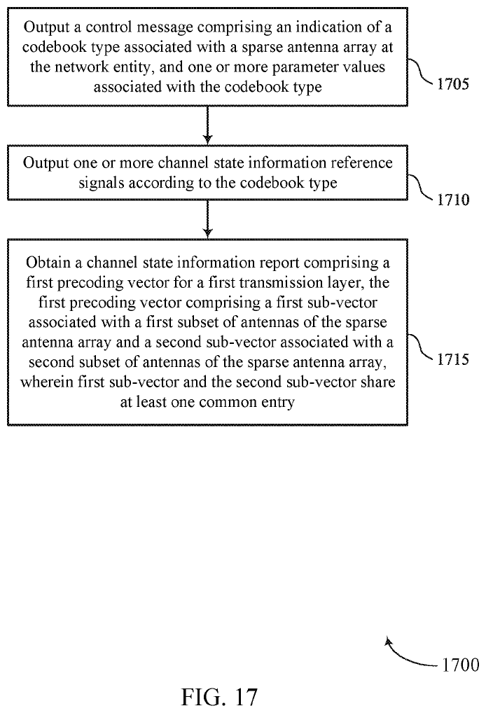

FIG. 17 shows a flowchart illustrating a method 1700 that supports codebook designs for CSI reporting with sparse antenna arrays in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting a control message including an indication of a codebook type associated with a sparse antenna array at the network entity, and one or more parameter values associated with the codebook type. The operations of 1705 may be performed in accordance with examples as disclosed herein. In some examples, aspects of the operations of 1705 may be performed by a codebook type manager 1225 as described with reference to FIG. 12.

At 1710, the method may include outputting one or more CSI-RSs according to the codebook type. The operations of 1710 may be performed in accordance with examples as disclosed herein. In some examples, aspects of the operations of 1710 may be performed by a CSI-RS manager 1230 as described with reference to FIG. 12.

At 1715, the method may include obtaining a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry. The operations of 1715 may be performed in accordance with examples as disclosed herein. In some examples, aspects of the operations of 1715 may be performed by a CSI report manager 1235 as described with reference to FIG. 12.

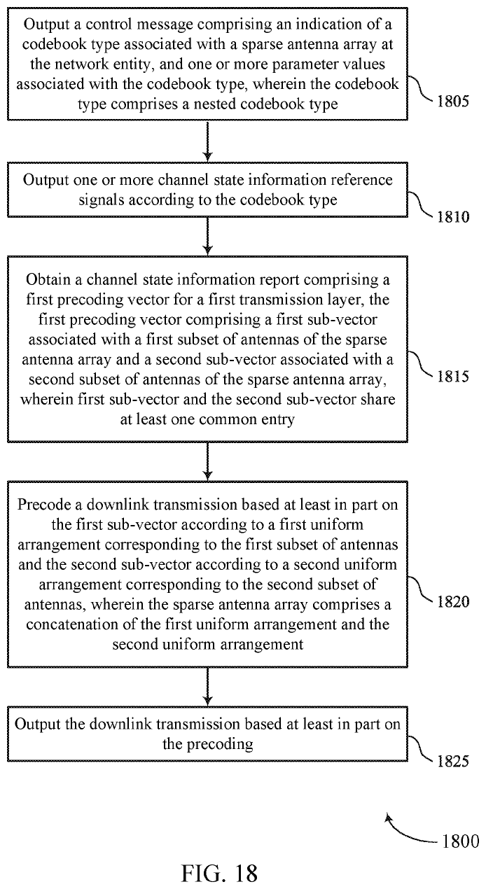

FIG. 18 shows a flowchart illustrating a method 1800 that supports codebook designs for CSI reporting with sparse antenna arrays in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include outputting a control message including an indication of a codebook type associated with a sparse antenna array at the network entity, and one or more parameter values associated with the codebook type, wherein the codebook type comprises a nested codebook type. The operations of 1805 may be performed in accordance with examples as disclosed herein. In some examples, aspects of the operations of 1805 may be performed by a codebook type manager 1225 as described with reference to FIG. 12.

At 1810, the method may include outputting one or more CSI-RSs according to the codebook type. The operations of 1810 may be performed in accordance with examples as disclosed herein. In some examples, aspects of the operations of 1810 may be performed by a CSI-RS manager 1230 as described with reference to FIG. 12.

At 1815, the method may include obtaining a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry. The operations of 1815 may be performed in accordance with examples as disclosed herein. In some examples, aspects of the operations of 1815 may be performed by a CSI report manager 1235 as described with reference to FIG. 12.

At 1820, the method may include precoding a downlink transmission based on the first sub-vector according to a first uniform arrangement corresponding to the first subset of antennas and the second sub-vector according to a second uniform arrangement corresponding to the second subset of antennas, where the sparse antenna array includes a concatenation of the first uniform arrangement and the second uniform arrangement. The operations of 1820 may be performed in accordance with examples as disclosed herein. In some examples, aspects of the operations of 1820 may be performed by a precoding manager 1240 as described with reference to FIG. 12.

At 1825, the method may include outputting the downlink transmission based on the precoding. The operations of 1825 may be performed in accordance with examples as disclosed herein. In some examples, aspects of the operations of 1825 may be performed by a precoding manager 1240 as described with reference to FIG. 12.

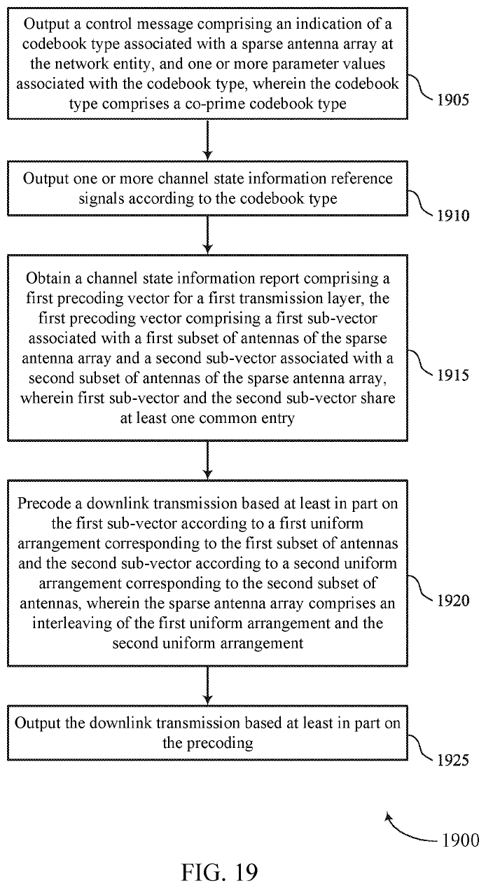

FIG. 19 shows a flowchart illustrating a method 1900 that supports codebook designs for CSI reporting with sparse antenna arrays in accordance with one or more aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include outputting a control message including an indication of a codebook type associated with a sparse antenna array at the network entity, and one or more parameter values associated with the codebook type, wherein the codebook type comprises a co-prime codebook type. The operations of 1905 may be performed in accordance with examples as disclosed herein. In some examples, aspects of the operations of 1905 may be performed by a codebook type manager 1225 as described with reference to FIG. 12.

At 1910, the method may include outputting one or more CSI-RSs according to the codebook type. The operations of 1910 may be performed in accordance with examples as disclosed herein. In some examples, aspects of the operations of 1910 may be performed by a CSI-RS manager 1230 as described with reference to FIG. 12.

At 1915, the method may include obtaining a CSI report including a first precoding vector for a first transmission layer, the first precoding vector including a first sub-vector associated with a first subset of antennas of the sparse antenna array and a second sub-vector associated with a second subset of antennas of the sparse antenna array, where the first sub-vector and the second sub-vector share at least one common entry. The operations of 1915 may be performed in accordance with examples as disclosed herein. In some examples, aspects of the operations of 1915 may be performed by a CSI report manager 1235 as described with reference to FIG. 12.

At 1920, the method may include precoding a downlink transmission based on the first sub-vector according to a first uniform arrangement corresponding to the first subset of antennas and the second sub-vector according to a second uniform arrangement corresponding to the second subset of antennas, where the sparse antenna array includes an interleaving of the first uniform arrangement and the second uniform arrangement. The operations of 1920 may be performed in accordance with examples as disclosed herein. In some examples, aspects of the operations of 1920 may be performed by a precoding manager 1240 as described with reference to FIG. 12.

At 1925, the method may include outputting the downlink transmission based on the precoding. The operations of 1925 may be performed in accordance with examples as disclosed herein. In some examples, aspects of the operations of 1925 may be performed by a precoding manager 1240 as described with reference to FIG. 12.

The following provides an overview of aspects of the present disclosure:

Aspect 1: A method for wireless communications at a UE, comprising: receiving a control message comprising an indication of a codebook type associated with a sparse antenna array at a network entity, and one or more parameter values associated with the codebook type; receiving one or more CSI-RSs according to the codebook type; and transmitting a CSI report comprising a first precoding vector for a first transmission layer, the first precoding vector comprising a first sub-vector associated with a first subset of antennas of the sparse antenna array and a second sub-vector associated with a second subset of antennas of the sparse antenna array, wherein the first sub-vector and the second sub-vector share at least one common entry.

Aspect 2: The method of aspect 1, wherein the codebook type comprises a nested codebook type, and wherein transmitting the CSI report comprises: generating the first sub-vector according to a first uniform arrangement corresponding to the first subset of antennas and the second sub-vector according to a second uniform arrangement corresponding to the second subset of antennas, and wherein the sparse antenna array comprises a concatenation of the first uniform arrangement and the second uniform arrangement.

Aspect 3: The method of aspect 2, wherein the one or more parameter values comprise a parameter value indicating a total number of antenna elements in the sparse array, and the concatenation is based at least in part on the parameter value indicating the total number of antenna elements.

Aspect 4: The method of any of aspects 1 through 3, wherein the codebook type comprises a co-prime codebook type, and wherein transmitting the CSI report comprises: generating the first sub-vector according to a first uniform arrangement corresponding to the first subset of antennas and the second sub-vector according to a second uniform arrangement corresponding to the second subset of antennas, and wherein the sparse antenna array comprises an interleaving of the first uniform arrangement and the second uniform arrangement.

Aspect 5: The method of aspect 4, wherein the one or more parameter values comprise a first co-prime integer value and a second co-prime integer value, and the interleaving is based at least in part on the first co-prime integer value and the second co-prime integer value.

Aspect 6: The method of any of aspects 1 through 5, further comprising: transmitting a capability message indicating that the UE is capable of receiving downlink signaling via the codebook type associated with the sparse antenna array, wherein receiving the control message is based at least in part on transmitting the capability message.

Aspect 7: The method of any of aspects 1 through 6, wherein the at least one common entry shared between the first sub-vector and the second sub-vector correspond to a same antenna element of the sparse antenna array.

Aspect 8: The method of any of aspects 1 through 7, further comprising: receiving, based at least in part on transmitting the CSI report, a downlink transmission; and decoding the downlink transmission based at least in part on the first precoding vector.

Aspect 9: The method of any of aspects 1 through 8, wherein the first precoding vector is one of a plurality of precoding vectors, each of the plurality of precoding vectors corresponding to a respective transmission layer of a plurality of transmission layers.

Aspect 10: The method of any of aspects 1 through 9, wherein the sparse antenna array comprises a plurality of antenna elements that are unevenly spaced with reference to each other on an antenna panel of the network entity.

Aspect 11: The method of any of aspects 1 through 10, wherein receiving the control message comprises: receiving a downlink control information message, a radio resource control message, a MAC-CE, or any combination thereof.

Aspect 12: A method for wireless communications at a network entity, comprising: outputting a control message comprising an indication of a codebook type associated with a sparse antenna array at the network entity, and one or more parameter values associated with the codebook type; outputting one or more CSI-RSs according to the codebook type; and obtaining a CSI report comprising a first precoding vector for a first transmission layer, the first precoding vector comprising a first sub-vector associated with a first subset of antennas of the sparse antenna array and a second sub-vector associated with a second subset of antennas of the sparse antenna array, wherein the first sub-vector and the second sub-vector share at least one common entry.

Aspect 13: The method of aspect 12, wherein the codebook type comprises a nested codebook type, further comprising: precoding a downlink transmission based at least in part on the first sub-vector according to a first uniform arrangement corresponding to the first subset of antennas and the second sub-vector according to a second uniform arrangement corresponding to the second subset of antennas, wherein the sparse antenna array comprises a concatenation of the first uniform arrangement and the second uniform arrangement; and outputting the downlink transmission based at least in part on the precoding.

Aspect 14: The method of aspect 13, wherein the one or more parameter values comprise a parameter value indicating a total number of antenna elements in the sparse array, and the concatenation is based at least in part on the parameter value indicating the total number of antenna elements.

Aspect 15: The method of any of aspects 12 through 14, wherein the codebook type comprises a coprime codebook type, further comprising: precoding a downlink transmission based at least in part on the first sub-vector according to a first uniform arrangement corresponding to the first subset of antennas and the second sub-vector according to a second uniform arrangement corresponding to the second subset of antennas, wherein the sparse antenna array comprises an interleaving of the first uniform arrangement and the second uniform arrangement; and outputting the downlink transmission based at least in part on the precoding;

Aspect 16: The method of aspect 15, wherein the one or more parameter values comprise a first co-prime integer value and a second co-prime integer value, and the interleaving is based at least in part on the first co-prime integer value and the second co-prime integer value.

Aspect 17: The method of any of aspects 12 through 16, further comprising: obtaining a capability message indicating that a UE is capable of receiving downlink signaling via the codebook type associated with the sparse antenna array, wherein outputting the control message is based at least in part on obtaining the capability message.

Aspect 18: The method of any of aspects 12 through 17, wherein the at least one common entry shared between the first sub-vector and the second sub-vector correspond to a same antenna element of the sparse antenna array.

Aspect 19: The method of any of aspects 12 through 18, wherein the first precoding vector is one of a plurality of precoding vectors, each of the plurality of precoding vectors corresponding to a respective transmission layer of a plurality of transmission layers.

Aspect 20: The method of any of aspects 12 through 19, wherein the sparse antenna array comprises a plurality of antenna elements that are unevenly spaced with reference to each other on an antenna panel of the network entity.

Aspect 21: The method of any of aspects 12 through 20, wherein outputting the control message comprises: outputting a downlink control information message, a radio resource control message, a MAC-CE, or any combination thereof.

Aspect 22: An apparatus for wireless communications at a UE, comprising a processor; memory coupled with the processor; and instructions stored in the memory and executable by the processor to cause the apparatus to perform a method of any of aspects 1 through 11.

Aspect 23: An apparatus for wireless communications at a UE, comprising at least one means for performing a method of any of aspects 1 through 11.

Aspect 24: A non-transitory computer-readable medium storing code for wireless communications at a UE, the code comprising instructions executable by a processor to perform a method of any of aspects 1 through 11.

Aspect 25: An apparatus for wireless communications at a network entity, comprising a processor; memory coupled with the processor; and instructions stored in the memory and executable by the processor to cause the apparatus to perform a method of any of aspects 12 through 21.

Aspect 26: An apparatus for wireless communications at a network entity, comprising at least one means for performing a method of any of aspects 12 through 21.

Aspect 27: A non-transitory computer-readable medium storing code for wireless communications at a network entity, the code comprising instructions executable by a processor to perform a method of any of aspects 12 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory in electronic communication with the processor; and
instructions stored in the memory, wherein the instructions are executable by the processor to:
receive a control message comprising an indication of a codebook type associated with a sparse antenna array at a network entity, and one or more parameter values associated with the codebook type;
receive one or more channel state information reference signals according to the codebook type; and
transmit a channel state information report comprising a first precoding vector for a first transmission layer, the first precoding vector comprising a first sub-vector associated with a first subset of antennas of the sparse antenna array and a second sub-vector associated with a second subset of antennas of the sparse antenna array, wherein the first sub-vector and the second sub-vector share at least one common entry.

2. The apparatus of claim 1, wherein the instructions executable by the processor to transmit the channel state information report comprise instructions executable by the processor to:
generate the first sub-vector according to a first uniform arrangement corresponding to the first subset of antennas and the second sub-vector according to a second uniform arrangement corresponding to the second subset of antennas, and wherein the sparse antenna array comprises a concatenation of the first uniform arrangement and the second uniform arrangement.

3. The apparatus of claim 1, wherein the one or more parameter values comprise a parameter value indicating a total number of antenna elements in the sparse antenna array, and the concatenation is based at least in part on the parameter value indicating the total number of antenna elements.

4. The apparatus of claim 1, wherein the instructions executable by the processor to transmit the channel state information report comprise instructions executable by the processor to cause the apparatus to:
generate the first sub-vector according to a first uniform arrangement corresponding to the first subset of antennas and the second sub-vector according to a second uniform arrangement corresponding to the second subset of antennas, and wherein the sparse antenna array comprises an interleaving of the first uniform arrangement and the second uniform arrangement.

5. The apparatus of claim 1, wherein the one or more parameter values comprise a first co-prime integer value and a second co-prime integer value, and the interleaving is based at least in part on the first co-prime integer value and the second co-prime integer value.

6. The apparatus of claim 1, wherein the instructions are further executable by the processor to:
transmit a capability message indicating that the UE is capable of receiving downlink signaling via the codebook type associated with the sparse antenna array, wherein receiving the control message is based at least in part on transmitting the capability message.

7. The apparatus of claim 1, wherein the at least one common entry shared between the first sub-vector and the second sub-vector correspond to a same antenna element of the sparse antenna array.

8. The apparatus of claim 1, wherein the instructions are further executable by the processor to:
receive, based at least in part on transmitting the channel state information report, a downlink transmission; and
decode the downlink transmission based at least in part on the first precoding vector.

9. The apparatus of claim 1, wherein the first precoding vector is one of a plurality of precoding vectors, each of the plurality of precoding vectors corresponding to a respective transmission layer of a plurality of transmission layers.

10. The apparatus of claim 1, wherein the sparse antenna array comprises a plurality of antenna elements that are unevenly spaced with reference to each other on an antenna panel of the network entity.

11. The apparatus of claim 1, wherein the instructions executable by the processor to receive the control message comprise instructions executable by the processor to:
receive a downlink control information message, a radio resource control message, a media access control control element, or any combination thereof.

12. An apparatus for wireless communications at a network entity, comprising:
a processor;
memory in electronic communication with the processor; and
instructions stored in the memory, wherein the instructions are executable by the processor to:
output a control message comprising an indication of a codebook type associated with a sparse antenna array at the network entity, and one or more parameter values associated with the codebook type;
output one or more channel state information reference signals according to the codebook type; and
obtain a channel state information report comprising a first precoding vector for a first transmission layer, the first precoding vector comprising a first sub-vector associated with a first subset of antennas of the sparse antenna array and a second sub-vector associated with a second subset of antennas of the sparse antenna array, wherein the first sub-vector and the second sub-vector share at least one common entry.

13. The apparatus of claim 12, wherein the codebook type comprises a nested codebook type, and wherein the instructions are executable by the processor to:
precode a downlink transmission based at least in part on the first sub-vector according to a first uniform arrangement corresponding to the first subset of antennas and the second sub-vector according to a second uniform arrangement corresponding to the second subset of antennas, wherein the sparse antenna array comprises a concatenation of the first uniform arrangement and the second uniform arrangement; and
output the downlink transmission based at least in part on the precoding.

14. The apparatus of claim 12, wherein the one or more parameter values comprise a parameter value indicating a total number of antenna elements in the sparse antenna array, and the concatenation is based at least in part on the parameter value indicating the total number of antenna elements.

15. The apparatus of claim 12, wherein the codebook type comprises a coprime codebook type, and wherein the instructions are executable by the processor to cause the apparatus to:
precode a downlink transmission based at least in part on the first sub-vector according to a first uniform arrangement corresponding to the first subset of antennas and the second sub-vector according to a second uniform arrangement corresponding to the second subset of antennas, wherein the sparse antenna array comprises an interleaving of the first uniform arrangement and the second uniform arrangement; and
output the downlink transmission based at least in part on the precoding.

16. The apparatus of claim 12, wherein the one or more parameter values comprise a first co-prime integer value and a second co-prime integer value, and the interleaving is based at least in part on the first co-prime integer value and the second co-prime integer value.

17. The apparatus of claim 12, wherein the instructions are further executable by the processor to:
obtain a capability message indicating that a user equipment (UE) is capable of receiving downlink signaling via the codebook type associated with the sparse antenna array, wherein outputting the control message is based at least in part on obtaining the capability message.

18. The apparatus of claim 12, wherein the at least one common entry shared between the first sub-vector and the second sub-vector correspond to a same antenna element of the sparse antenna array.

19. The apparatus of claim 12, wherein the first precoding vector is one of a plurality of precoding vectors, each of the plurality of precoding vectors corresponding to a respective transmission layer of a plurality of transmission layers.

20. The apparatus of claim 12, wherein the sparse antenna array comprises a plurality of antenna elements that are unevenly spaced with reference to each other on an antenna panel of the network entity.

21. The apparatus of claim 12, wherein the instructions executable by the processor to output the control message comprise instructions executable by the processor to cause the apparatus to:
output a downlink control information message, a radio resource control message, a media access control control element, or any combination thereof.

22. A method for wireless communications at a user equipment (UE), comprising:
receiving a control message comprising an indication of a codebook type associated with a sparse antenna array at a network entity, and one or more parameter values associated with the codebook type;
receiving one or more channel state information reference signals according to the codebook type; and
transmitting a channel state information report comprising a first precoding vector for a first transmission layer, the first precoding vector comprising a first sub-vector associated with a first subset of antennas of the sparse antenna array and a second sub-vector associated with a second subset of antennas of the sparse antenna array, wherein the first sub-vector and the second sub-vector share at least one common entry.

23. The method of claim 22, wherein the codebook type comprises a nested codebook type, and wherein transmitting the channel state information report comprises:
generating the first sub-vector according to a first uniform arrangement corresponding to the first subset of antennas and the second sub-vector according to a second uniform arrangement corresponding to the second subset of antennas, and wherein the sparse antenna array comprises a concatenation of the first uniform arrangement and the second uniform arrangement.

24. The method of claim 22, wherein the one or more parameter values comprise a parameter value indicating a total number of antenna elements in the sparse antenna array, and the concatenation is based at least in part on the parameter value indicating the total number of antenna elements.

25. The method of claim 22, wherein the codebook type comprises a co-prime codebook type, and wherein transmitting the channel state information report comprises:
generating the first sub-vector according to a first uniform arrangement corresponding to the first subset of antennas and the second sub-vector according to a second uniform arrangement corresponding to the second subset of antennas, and wherein the sparse antenna array comprises an interleaving of the first uniform arrangement and the second uniform arrangement.

26. The method of claim 22, further comprising:
transmitting a capability message indicating that the UE is capable of receiving downlink signaling via the codebook type associated with the sparse antenna array, wherein receiving the control message is based at least in part on transmitting the capability message.

27. The method of claim 22, further comprising:
receiving, based at least in part on transmitting the channel state information report, a downlink transmission; and
decoding the downlink transmission based at least in part on the first precoding vector.

28. A method for wireless communications at a network entity, comprising:
outputting a control message comprising an indication of a codebook type associated with a sparse antenna array at the network entity, and one or more parameter values associated with the codebook type;
outputting one or more channel state information reference signals according to the codebook type; and
obtaining a channel state information report comprising a first precoding vector for a first transmission layer, the first precoding vector comprising a first sub-vector associated with a first subset of antennas of the sparse antenna array and a second sub-vector associated with a second subset of antennas of the sparse antenna array, wherein the first sub-vector and the second sub-vector share at least one common entry.

29. The method of claim 28, wherein the codebook type comprises a nested codebook type, further comprising:
precoding a downlink transmission based at least in part on the first sub-vector according to a first uniform arrangement corresponding to the first subset of antennas and the second sub-vector according to a second uniform arrangement corresponding to the second subset of antennas, wherein the sparse antenna array comprises a concatenation of the first uniform arrangement and the second uniform arrangement; and
outputting the downlink transmission based at least in part on the precoding.

30. The method of claim 28, wherein the codebook type comprises a coprime codebook type, further comprising:
precoding a downlink transmission based at least in part on the first sub-vector according to a first uniform arrangement corresponding to the first subset of antennas and the second sub-vector according to a second uniform arrangement corresponding to the second subset of antennas, wherein the sparse antenna array comprises an interleaving of the first uniform arrangement and the second uniform arrangement; and
outputting the downlink transmission based at least in part on the precoding.
